(19) United States
(12) Patent Application Publication
(10) Pub. No.: US 2023/0327494 A1
(43) Pub. Date: Oct. 12, 2023

(54) AUTOMATICALLY-ALIGNING MAGNETIC FIELD SYSTEM AND METHOD OF FABRICATION

(71) Applicant: The Alfred E. Mann Foundation for Scientific Research, Valencia, CA (US)

(72) Inventors: Susanna Lin, Los Angeles, CA (US); Brian R. Dearden, Pasadena, CA (US); Justin Cheng-Tsu Loo, San Marino, CA (US)

(21) Appl. No.: 18/178,414

(22) Filed: Mar. 3, 2023

Related U.S. Application Data
(60) Provisional application No. 63/325,097, filed on Mar. 29, 2022.

(51) Int. Cl. B22F 12/41; H02J 50/40; B22F 10/25; H02J 50/10

(52) U.S. Cl. CPC H02J 50/402; B22F 10/25; B22F 12/41; H02J 50/10; H01F 1/344

(57) ABSTRACT

A wireless power transfer device includes a first transmitting coil oriented along a first axis and including a first ferrite rod; a second transmitting coil on the first transmitting coil, oriented along a second axis different from the first axis, and including a second ferrite rod; and a nonmagnetic layer magnetically decoupling the first ferrite rod from the second ferrite rod in an area of overlap between the first and second ferrite rods, the first ferrite rod and the nonmagnetic layer being fabricated utilizing additive manufacturing.

### CROSS-REFERENCE TO RELATED APPLICATIONS

This application claims priority to, and the benefit of, U.S. Provisional Application No. 63/325,097, filed on Mar. 29, 2022, the entire content of which is hereby incorporated by reference.

This application is related to U.S. Non-provisional Application No. 17/517,518, filed on Nov. 2, 2021, the entire content of which is hereby incorporated by reference.

### BACKGROUND

### 1. Field

The present disclosure relates to a wireless power transfer device configured to generate a magnetic field and control a direction of the magnetic field and to a method of additive fabricating the wireless power transfer device

### 2. Description of the Related Art

A primary coil may be driven with AC current to generate an oscillating magnetic field, and the magnetic field can generate a current in a secondary coil in proximity to the primary coil via electromagnetic induction. Electromagnetic induction can be utilized to wirelessly transfer energy and is utilized in one or more suitable industries and devices such as electric vehicles, medical devices, and electronic devices. The magnitude of the current generated in the secondary coil, and thus the effectiveness of the primary coil in transferring energy to the secondary coil, depends on how aligned the magnetic field is with the secondary coil. However, in related art devices, the primary coil cannot control the direction of the magnetic field, and improving alignment between the magnetic field with the secondary coil requires physically moving and/or orientating the primary coil or the secondary coil, which may be inconvenient and cumbersome.

Additive manufacturing apparatuses of the related art are generally configured to fabricate single-material components, and thus, are currently not configured for fabricating components of wireless power transfer devices that include multiple materials, such as components comprising a magnetic part (e.g., a ferrite part) and a nonmagnetic part (e.g., a plastic or polymer part). There is thus a need for additive manufacturing apparatuses configured to fabricate components including multiple materials.

### SUMMARY

The present disclosure relates to one or more suitable embodiments of a wireless power transfer system including a wireless power transfer device. In one embodiment, the wireless power transfer device includes a first transmitting coil oriented along a first axis and including a first ferrite rod; and a second transmitting coil on the first transmitting coil, oriented along a second axis different from the first axis, and including a second ferrite rod; and a nonmagnetic layer magnetically decoupling the first ferrite rod from the second ferrite rod in an area of overlap between the first and second ferrite rods, the first ferrite rod and the nonmagnetic layer being fabricated utilizing additive manufacturing.

The present disclosure relates to one or more suitable embodiments of an additive manufacturing apparatus. In one embodiment, the additive manufacturing apparatus includes a ferrite material fabrication structure configured to additive fabricate a ferrite rod from a ferrite material precursor; and a nonmagnetic material fabrication structure configured to additive fabricate a nonmagnetic layer from a nonmagnetic material precursor, the nonmagnetic layer being on the ferrite rod.

The present disclosure relates to one or more suitable embodiments of a method of fabricating a wireless power transfer device including a ferrite layer and a nonmagnetic layer on the ferrite layer. In one embodiment, the method includes utilizing a ferrite material precursor to additive fabricate the ferrite layer; and utilizing a nonmagnetic material precursor to additive fabricate the nonmagnetic layer.

This summary is provided to introduce a selection of features and concepts of embodiments of the present disclosure that are further described below in the detailed description. This summary is not intended to identify critical or essential features of the claimed subject matter, nor is it intended to be used in limiting the scope of the claimed subject matter.

### BRIEF DESCRIPTION OF THE DRAWINGS

The accompanying drawings, together with the specification, illustrate example embodiments of the present disclosure. These drawings, together with the description, serve to better explain aspects and principles of the present disclosure.

FIG. 1 shows a schematic view of a wireless power transfer system according to some embodiments.

FIG. 2 shows a perspective view of first and second transmitting coils of a wireless power transfer device according to some embodiments.

FIG. 3 shows a plan view of the first and second transmitting coils of FIG. 2.

FIG. 4 shows a side view of the first and second transmitting coils of FIG. 2.

FIG. 5A shows a plan view of first and second transmitting coils of a wireless power transfer device according to some embodiments and the direction of a magnetic field generated by the first and second transmitting coils pursuant to five states in which the first and second transmitting coils may be driven.

FIGS. 5B-5F show graphs of the voltages applied to the first and second transmitting coils as a function of time for the five states of FIG. 5A.

FIG. 6A shows a schematic view of a wireless power transfer system according to some embodiments.

FIG. 6B shows a schematic side view of the wireless power transfer system of FIG. 6A with the wireless power transfer device above the electronic device.

FIG. 6C shows a schematic side view of the wireless power transfer system of FIG. 6A with the electronic device at the side of the wireless power transfer device.

FIG. 7A shows a schematic view of an electronic device according to some embodiments.

FIG. 7B shows a schematic view of an electronic device according to some embodiments.

FIG. 8 shows a method flow chart for an initialization mode according to some embodiments.

FIG. 9 shows a method flow chart for an error mode according to some embodiments.

FIG. 10 shows a method flow chart for a find electronic device mode according to some embodiments.

FIG. 11 shows a method flow chart for an optimize location mode according to some embodiments.

FIG. 12 shows a method flow chart for an electronic device charging mode according to some embodiments.

FIG. 13 shows a method flow chart for a wireless power transfer device charging mode according to some embodiments.

FIG. 14 shows a cross-sectional view of a part of a wireless power transfer device according to some embodiments.

FIGS. 15 and 16 show schematic diagrams of additive manufacturing apparatuses according to some embodiments.

FIG. 17 shows a top view of a part of an additive manufacturing apparatus according to some embodiments.

FIG. 18 shows a schematic cross-sectional view along line 18-18 of the part of the additive manufacturing apparatus of FIG. 17, along with other components of the additive manufacturing apparatus of FIG. 17, according to some embodiments.

FIG. 19 shows a schematic cross-sectional view along line 19-19 of the part of the additive manufacturing apparatus of FIG. 17, along with other components of the additive manufacturing apparatus of FIG. 17, according to some embodiments.

FIGS. 20-22 show schematic cross-sectional views of additive manufacturing apparatuses according to some embodiments.

FIGS. 23-27 show methods of additive fabricating at least part of a wireless power transfer device according to some embodiments.

FIG. 28 shows a cross-sectional view of a part of a wireless power transfer device according to some embodiments.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. As used herein, the term “and/or” includes any and all combinations of one or more of the associated listed items. As used herein, the terms “use,” “using,” and “used” may be considered synonymous with the terms “utilize,” “utilizing,” and “utilized,” respectively.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the present disclosure.

It will be understood that when an element or layer is referred to as being “on”, “connected to”, “coupled to”, or “adjacent to” another element or layer, it can be directly on, connected to, coupled to, or adjacent to the other element or layer, or one or more intervening element(s) or layer(s) may be present. In contrast, when an element or layer is referred to as being “directly on,” “directly connected to”, “directly coupled to”, or “immediately adjacent to” another element or layer, there are no intervening elements or layers present.

Spatially relative terms, such as “beneath”, “below”, “lower”, “under”, “above”, “upper” and the like, may be used herein for ease of description to describe one element or feature’s relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

As used herein, the term “substantially” and similar terms are used as terms of approximation and not as terms of degree, and are intended to account for the inherent deviations in measured or calculated values that would be recognized by those of ordinary skill in the art. Also, the terms “about,” “approximately,” and similar terms, when used herein in connection with a numerical value or a numerical range, are inclusive of the stated value and mean within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations, or within ± 30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

It will be understood that methods illustrated and described herein of utilizing a wireless power transfer system and of fabricating at least part of a wireless power transfer device do not require all of the illustrated and described states or tasks, are not limited to the illustrated and described stages or tasks, and are not limited to performing the stages or tasks in the illustrated or described order. Rather, the present disclosure includes, for any method illustrated or described herein, methods performed without one or more of the illustrated or described stages or tasks and/or with one or more additional stages or tasks (e.g., one or more additional stages or tasks disclosed herein), and the stages or tasks of such methods may be performed in any suitable order.

Example embodiments of the present disclosure will now be described with reference to the accompanying drawings. In the drawings, the same or similar reference numerals refer to the same or similar elements throughout. As used herein, the use of the term “may,” when describing embodiments of the present disclosure, refers to “one or more embodiments of the present disclosure.”

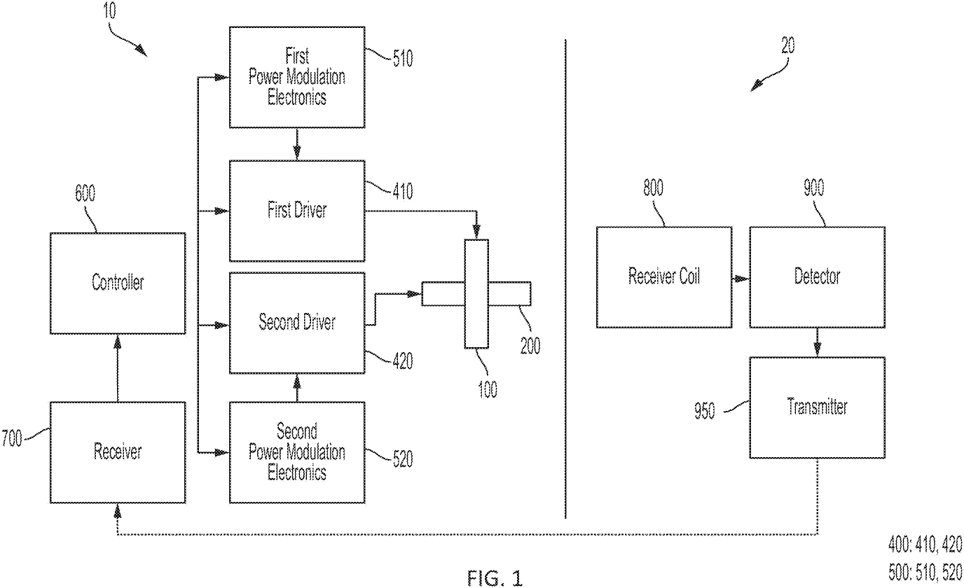

FIG. 1 schematically illustrates a wireless power transfer system according to some embodiments. The wireless power transfer system may include a wireless power transfer device 10 and an electronic device 20.

The wireless power transfer device 10 may include a first transmitting coil 100, a second transmitting coil 200 on (e.g., positioned on) the first transmitting coil 100, a driver 400 configured to drive the first transmitting coil 100 with a first AC current and the second transmitting coil 200 with a second AC current, power modulation electronics 500 configured to modulate the first and second AC currents provided by the driver 400, a controller 600 (e.g., a microcontroller) configured to control the operations of the driver 400 and the power modulation electronics 500, and a receiver 700 for receiving information (e.g., information transmitted by the electronic device 20).

The electronic device 20 may include a receiver coil 800, a detector 900 configured to detect information about power received in the receiver coil 800, and a transmitter 950 configured to transmit information (e.g., transmit information to the wireless power transfer device 10). In some embodiments, the transmitter 950 may be a radio or an RF transmitter.

The wireless power transfer device 10 may be configured to generate an oscillating magnetic field by driving the first and second transmitting coils 100 and 200 with the first and second AC currents, respectively, and to rotate the direction of the magnetic field by controlling (e.g., setting or adjusting) a first magnitude of the first AC current, a second magnitude of the second AC current, and a phase difference between the first and second AC currents (e.g., the wireless power transfer device 10 is configured to rotate the direction of the magnetic field by differentially driving the first and second transmitting coils 100 and 200). When the wireless power transfer device 10 generates the magnetic field and the electronic device 20 is in the proximity to the wireless power transfer device 10, a current may be generated in the receiver coil 800 by electromagnetic induction (e.g., wireless resonant induction). The detector 900 may be configured to detect information (e.g., power, amplitude, etc.) about the current generated in the receiver coil 800, and the transmitter 950 may be to transmit (e.g., wirelessly transmit) the detected information to outside of the electronic device 20, for example, to the receiver 700 of the wireless power transfer device 10. The controller 600 may control the driver 400 and the power modulation electronics 500 based on the information received by the receiver 700 to control the direction of the magnetic field at the receiver coil 800.

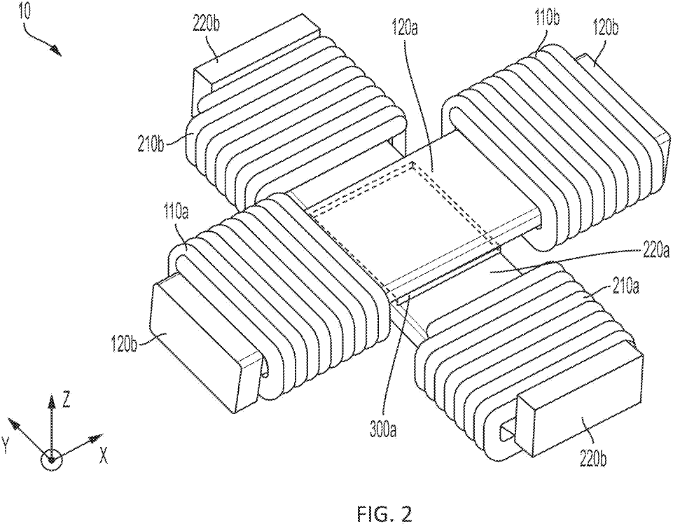

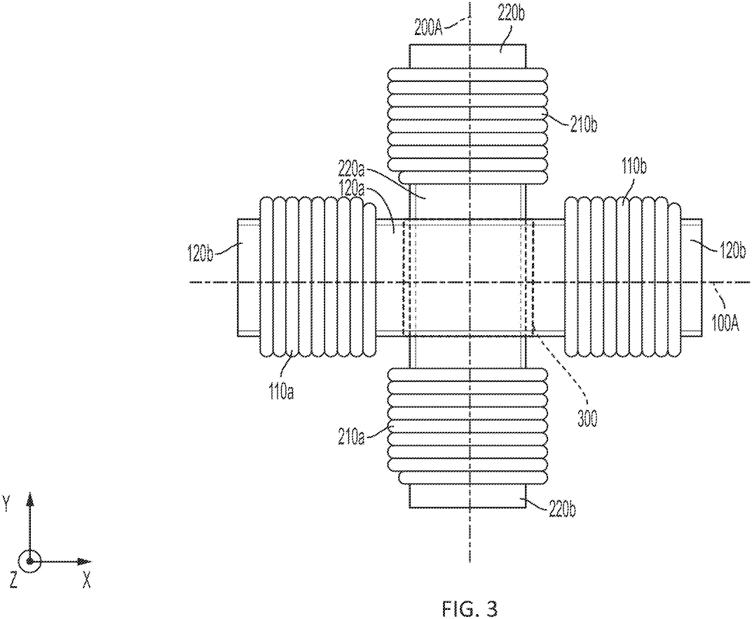

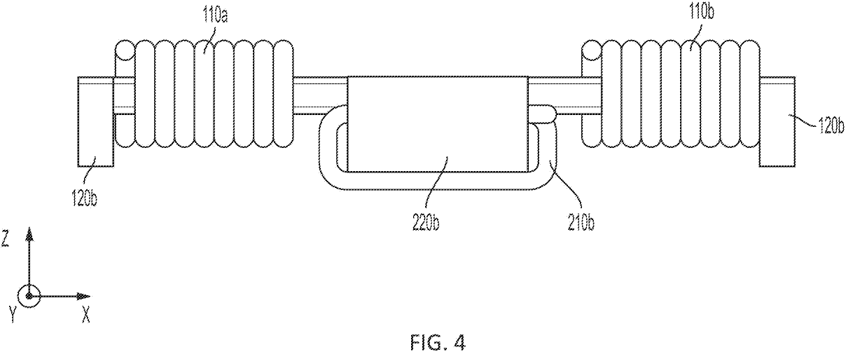

The first and second transmitting coils 100 and 200 will now be described in more detail with reference to FIGS. 2-4. FIG. 2 shows a perspective view of the first and second transmitting coils 100 and 200 according to some embodiments, FIG. 3 shows a plan view of the first and second transmitting coils 100 and 200 of FIG. 2, and FIG. 4 shows a side view of the first and second transmitting coils 100 and 200 of FIG. 2.

The first transmitting coil 100 may include a first rod 120 and a first wire 110 wound around the first rod 120, and the second transmitting coil 200 may include a second rod 220 and a second wire 210 wound around the second rod 220.

The first transmitting coil 100 may be aligned along a first axis 100A, and the second transmitting coil 200 may be aligned along a second axis 200A different from the first axis 100A. In some embodiments, the second axis 200A is perpendicular (or substantially perpendicular) to the first axis 100A. For example, an angle between the second axis 200A and the first axis 100A may be approximately (about) 90°. When the first and second axes 100A and 200A are perpendicular, coupling between the first and second transmitting coils 100 and 200 may be reduced or substantially prevented or reduced. Coupling between the first and second transmitting coils 100 and 200 may be at a maximum when the first and second axes 100A and 200A are parallel, and coupling between the first and second transmitting coils 100 and 200 may decrease as an angle between the first and second axes 100A and 200A increases towards 90°, at which point coupling is at a minimum. However, the angle between the first axis 100A and the second axis 200A may be any suitable angle, for example, within the range of about 45° to about 90°. In FIGS. 2-4, the first axis 100A is shown as being aligned along an X-axis, and the second axis 200A is shown as being aligned along a Y-axis.

The second transmitting coil 200 may be on (e.g., above) the first transmitting coil 100 and may overlap the first transmitting coil 100 in a plan view (shown in FIG. 3) at an area of overlap 300. In some embodiments, the area of overlap 300 corresponds to a center region of the first transmitting coil 100 and a center region of the second transmitting coil 200. The second transmitting coil 200 may be spaced apart (e.g., separated) from the first transmitting coil 100 in a thickness direction (e.g., a Z-axis direction) at the area of overlap 300.

An intermediate space 300a between (e.g., directly between) the first and second transmitting coils 100 and 200 in the area of overlap 300 may include (e.g., be filled or at least partially filled with) a nonmagnetic material having a low permeability, for example, air, plastic (e.g., thermoplastic), foam, one or more polymers, a low permeability organic or inorganic material, one or more non-ferrimagnetic materials, one or more low permeability metals (e.g., aluminum and/or copper), etc. The intermediate space 300a may also include a binder (e.g., an organic or inorganic binder) to hold the nonmagnetic material together. The nonmagnetic material may be capable of being additive fabricated, for example, from a powder, from a polymerizable liquid, and/or from an extrudable composition. In some embodiments, when the intermediate space 300a is filled with air, a frame or housing may be utilized to hold the first and second transmitting coils 100 and 200 and/or to maintain the relative positions of the first and second transmitting coils 100 and 200 with respect to each other. In some embodiments, the material in the intermediate space 300a has a relative permeability of equal to or less than about 5, for example, in the range of about 1 to about 1.5. In some embodiments, the material in the intermediate space 300a may be diamagnetic (e.g., a material having a relative permeability in the range of about 0 to about 1). Therefore, in some embodiments, the second transmitting coil 200 does not contact the first transmitting coil 100, and the first and second transmitting coils 100 and 200 are magnetically independent (e.g., magnetically decoupled and/or magnetically isolated from each other) and/or electrically independent (e.g., electrically decoupled and/or electrically isolated) from each other. Because the first and second transmitting coils 100 and 200 are not in contact, coupling between the first and second transmitting coils 100 and 200 may be reduced or substantially prevented. For example, the first transmitting coil 100 may generate a first magnetic field without being significantly influenced by the presence of the second transmitting coil 200, and the second transmitting coil 200 may generate a second magnetic field without being significantly influenced by the presence of the first transmitting coil 100. A magnetic field generated by the wireless power transfer device 10 may be a superposition of the first and second magnetic fields generated by the first and second transmitting coils 100 and 200, respectively.

The first rod 120 may include (e.g., be) a magnetic material having a high permeability, such as a ferrimagnetic material (e.g., soft ferrite material), such as nickel-or manganese-based ferrites (e.g., MnZn, NiZn, and/or the like). The magnetic material may include a ferrite and a binder material (e.g., an organic or inorganic binder). The magnetic material may be capable of being additive fabricated, for example, from a powder, from a polymerizable liquid, and/or from an extrudable composition.

The magnetic material may increase the intensity of a magnetic field generated by the first transmitting coil 100 compared to an otherwise comparable coil without the magnetic rod. In some embodiments, the material of the first rod 120 may have a relative permeability equal to or greater than about 5, for example, in the range of about 10 to about 10,000. The second rod 220 may include any material that the first rod 120 may include, and the second rod 220 may include a material that is the same as, or different from, a material included in the first rod 120. In some embodiments, a ratio of the permeability of a material in the first rod 120 to the permeability of the material in the intermediate space 300a may be equal to or greater than approximately (about) 5. When the permeability of the materials of the first and second rods 120 and 220 are significantly larger than the permeability of the material in the intermediate space 300a, coupling between the first and second transmitting coils 100 and 200 may be reduced or substantially prevented. For example, a magnetic field flowing through the first rod 120 may be blocked (by the material in the intermediate space 300a) from permeating through the intermediate space 300a and into the magnetic material of the second rod 220. Thus, the presence of the second transmitting coil 200 may not substantially affect the first magnetic field generated by the first transmitting coil 100, and vice versa.

The first rod 120 may include a first main rod 120a and first thick portion (e.g., a tab or a flange) 120b at an end (e.g., both ends) of the first main rod 120a, and the second rod 220 may include a second main rod 220a and a second thick portion (e.g., a tab or a flange) 220b at an end (e.g., both ends) of the second main rod 220a. The first main rod 120a may have any suitable shape. The second main rod 220a may have any shape that the first main rod 120a may have, and the shape of the second main rod 220a may be the same as, or different from, the shape of the first main rod 120a. In some embodiments, the first main rod 120a has a cylindrical shape. In other embodiments, the first main rod 120a has a rectangular shape having a length along the X-axis, a width along the Y-axis, and a thickness along the Z-axis. The width of the first main rod 120a may be less than the length of the first main rod 120a, and the thickness of the first main rod 120a may be less than the width of the first main rod 120a, but the present disclosure is not limited thereto.

A thickness of the intermediate space 300a may be relatively small compared to the dimensions of the first and second transmitting coils 100 and 200. For example, the thickness of the intermediate space 300a may be less than the length, the width, and/or the thickness of the first main rod 120a. Because the first and second magnetic fields generated by the first and second transmitting coils 100 and 200 will each generally decrease in magnitude as respective distances from the first and second transmitting coils 100 and 200 increase, it is advantageous for the thickness of the intermediate space 300a to be small in order to minimize or at least reduce a disparity between a distance between the electronic device 20 and the first transmitting coil 100 and a distance between the electronic device 20 and the second transmitting coil 200. When the disparity is large, one of the first and second transmitting coils 100 and 200 may have an unintended disproportionate effect on the electronic device 20 compared to the other one of the first and second transmitting coils 100 and 200. Accordingly, in one or more embodiments, the thickness of the intermediate space 300a may be sufficiently small such that the first and second transmitting coils 100 and 200 are substantially coplanar to advantageously minimize or at least reduce the disproportionate effect of one of the first and second transmitting coils 100 and 200 on the electronic device 20.

In some embodiments, a thickness of the first main rod 120a at the area of overlap 300 is less than a thickness of the first main rod 120a at an area outside of the area of overlap 300. For example, the first main rod 120a may have an indent or recess (e.g., a step) at the area of overlap 300 that faces the second main rod 220a. When one or both of the first and second main rods 120a and 220a have such an indent or recess, the distance between the first and second transmitting coils 100 and 200 may be reduced. In some embodiments, the indent or recess in one or both of the first and second main rods 120a and 220a may allow the first and second wires 110 and 210 to be coplanar (or substantially coplanar).

The first thick portion 120b may be at an end (or end portion) of the first main rod 120a, and a thickness of the first thick portion 120b may be greater than a thickness of the first main rod 120a. For example, as shown in FIG. 3, the first thick portion 120b may protrude toward the second transmitting coil 200 (e.g., in the negative Z-axis direction). Similarly, the second thick portion 220b may be at an end (or end portion) of the second main rod 220a, and a thickness of the second thick portion 220b may be greater than a thickness of the second main rod 220a. For example, the second thick portion 220b may protrude toward the first transmitting coil 100 (e.g., in the Z-axis direction). For example, the second thick portion 220b of the second transmitting coil 200 may protrude in a direction opposite to a protruding direction of the first thick portion 120b of the first transmitting coil 100. Because the first and second thick portions 120b and 220b of the first and second transmitting coils 100 and 200 may protrude toward the second and first transmitting coils 200 and 100, respectively, the distance along the Z-axis direction between the ends of the first rod 120 and the ends of the second rod 220 may be reduced or eliminated, and thus, the ends of the first and second rods 120 and 220 may be substantially coplanar.

The first wire 110 may be wound around the first rod 120 in any suitable configuration. The second wire 210 may be wound around the second rod 220 in any configuration that the first wire 110 may be wound around the first rod 120. In some embodiments, the first wire 110 is wound around the first main rod 120a and is not wound around the first thick portion 120b. The first wire 110 may be wound around substantially the entire length of the first main rod 120a. For example, the first wire 110 and the first main rod 120a may form a solenoid. In some embodiments, the first wire 110 is wound around two ends (or two end portions) of the first main rod 120a to form first and second sub-coils 110a and 110b at the two ends (or two end portions) of the first main rod 120a, and the first wire 110 exposes, and is not wound around, a portion (e.g., an exposed intermediate or central portion) of the first main rod 120a between the first and second sub-coils 110a and 110b. The exposed portion of the first main rod 120a may include a portion of the first main rod 120a corresponding to the area of overlap 300 between the first and second transmitting coils 100 and 200. When the first wire 110 is not wound around the first main rod 120a at the area of overlap 300, the thickness of the first transmitting coil 100 at the area of overlap 300 may be reduced.

The first sub-coil 110a may be electrically coupled (e.g., electrically connected) to the second sub-coil 110b in series or in parallel. When the first sub-coil 110a is electrically coupled (e.g., electrically connected) to the second sub-coil 110b in series, the first wire 110 may electrically couple (e.g., electrically connect) the first sub-coil 110a to the second sub-coil 110b by extending across the area of overlap 300 on the first main rod 120a and on a side of the first main rod 120a facing away from the second transmitting coil 200.

In some embodiments, the first sub-coil 110a is not electrically coupled (e.g., electrically connected) to the second sub-coil 110b, and the first and second sub-coils 110a and 110b are separately driven. In such embodiments, the first and second sub-coils 110a and 110b may be synchronously driven so that the magnetic fields generated by the first and second sub-coils 110a and 110b oscillate in phase.

The wireless power transfer device 10 may generate a magnetic field by driving the first AC current through the first wire 110 and/or driving the second AC current through the second wire 210. The first and second AC currents may be driven in phase (i.e., with about 0° phase difference between the first and second AC currents) or about 180° out of phase. A direction of the magnetic field generated by the wireless power transfer device 10 may be controlled or selected by controlling (e.g., setting or changing) a first amplitude of the first AC current, a second amplitude of the second AC current, and a phase difference between the first and second AC currents (e.g., the wireless power transfer device 10 is configured to rotate the direction of the magnetic field by differentially driving the first and second transmitting coils 100 and 200). Accordingly, the direction of the magnetic field can be rotated by changing these parameters.

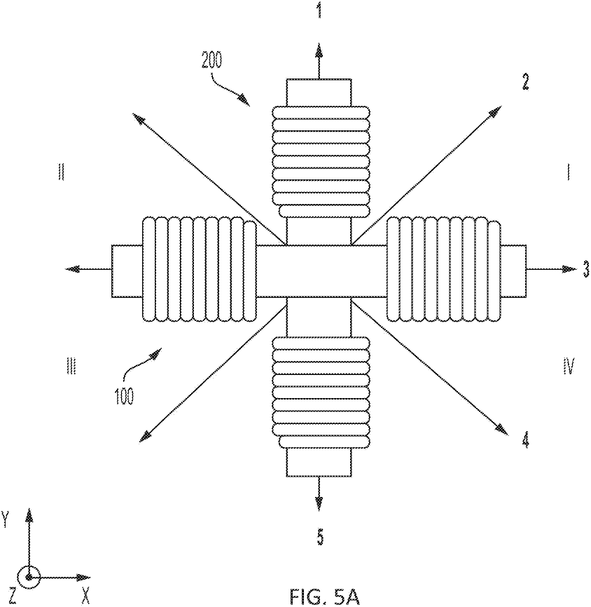

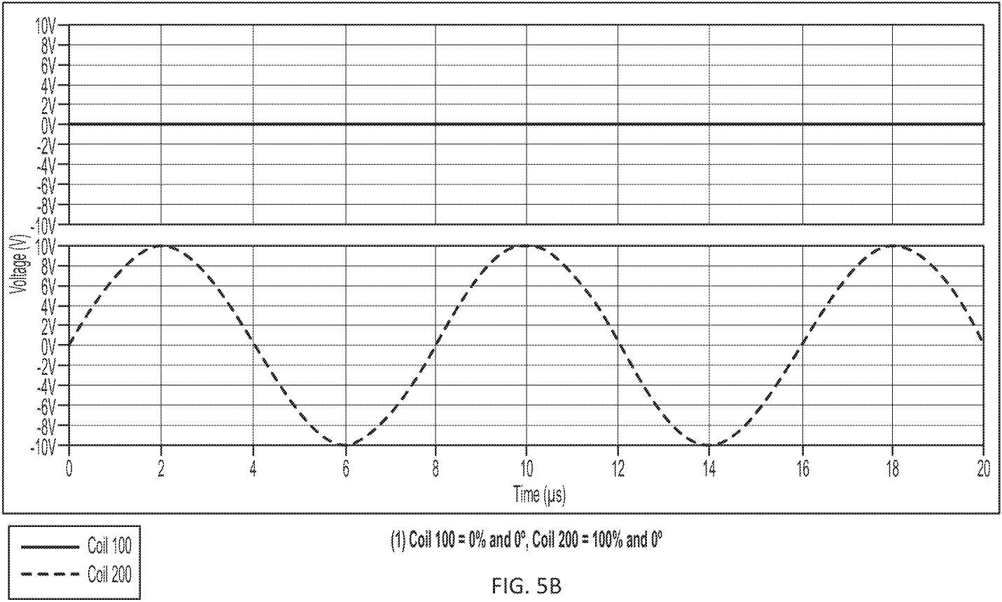

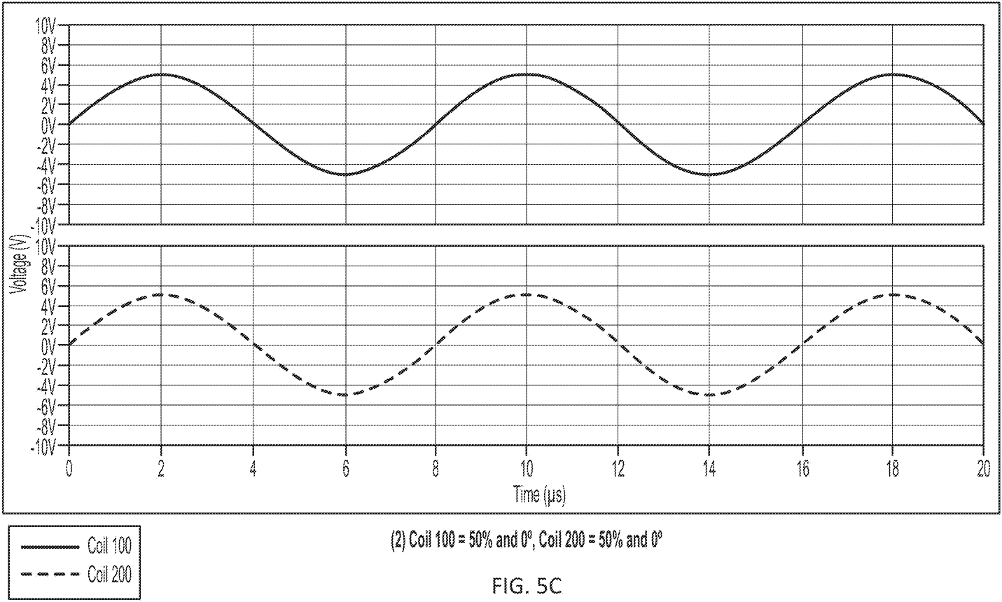

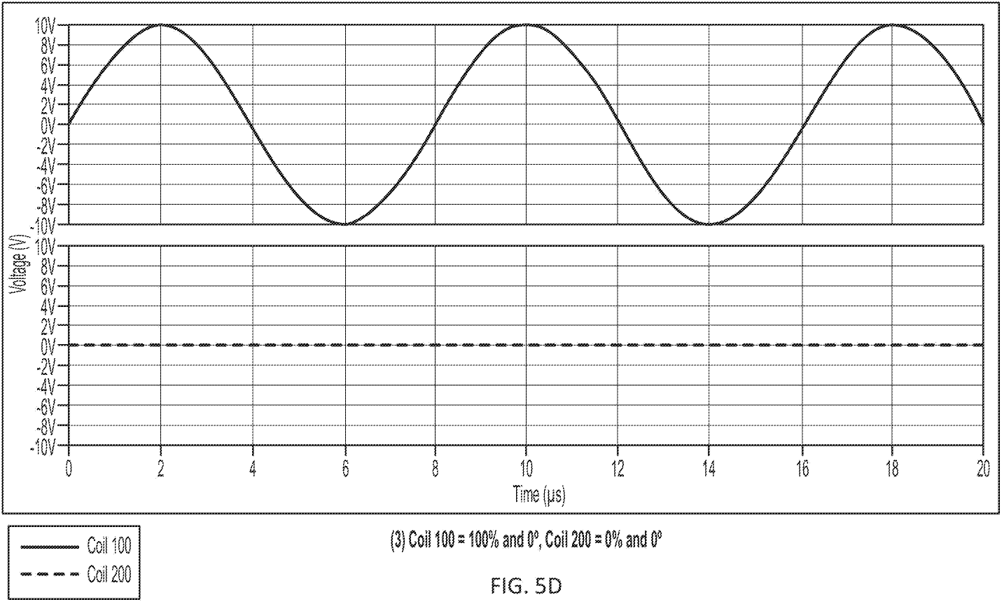

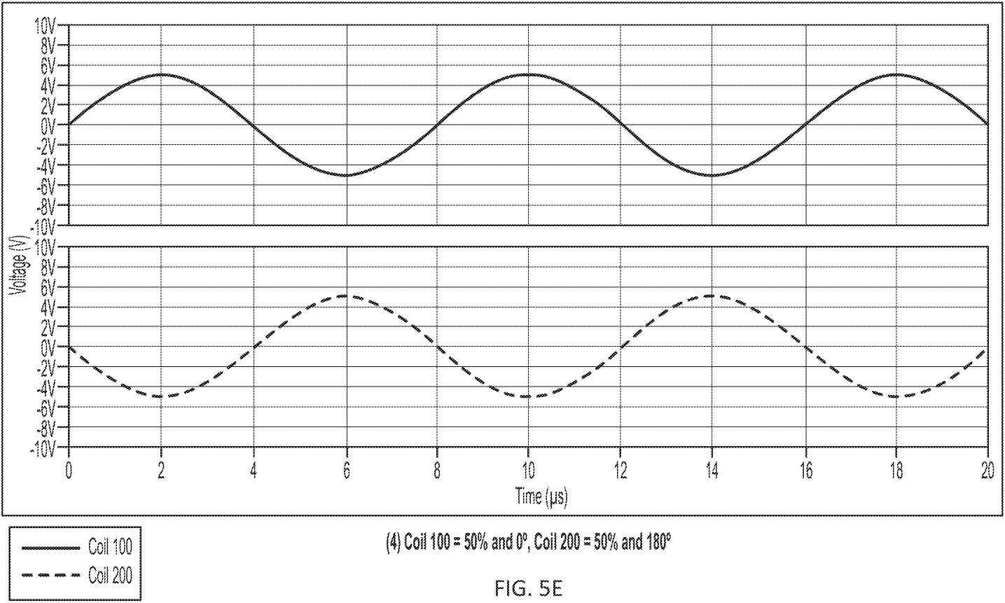

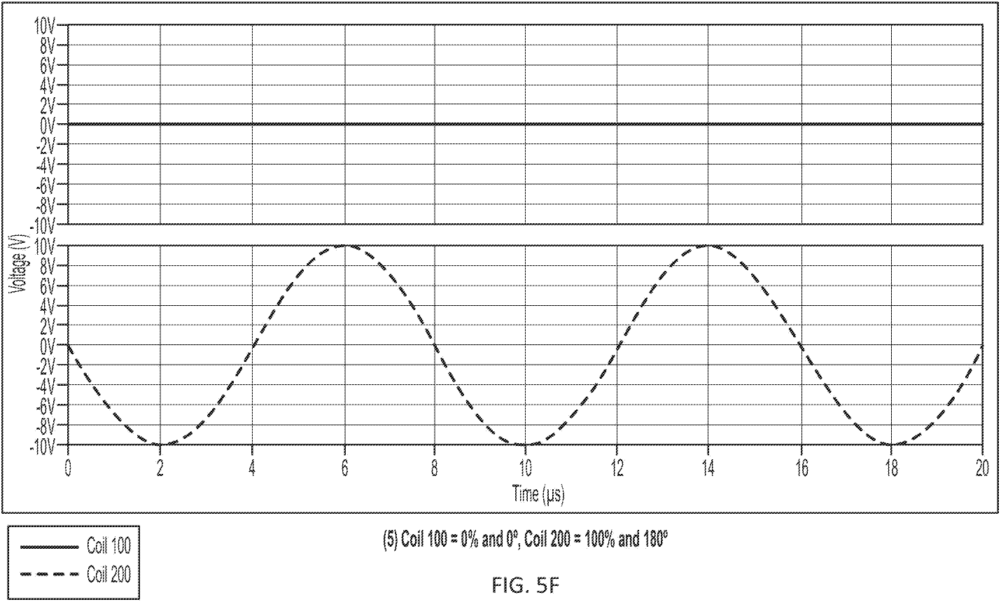

FIG. 5A shows how the direction of a magnetic field generated by the wireless power transfer device 10 can be rotated according to a non-limiting example. FIGS. 5B-5F show graphs of the voltages applied to the first and second transmitting coils 100 and 200 as a function of time for five states shown in FIG. 5A. The numerical values shown in the graphs of FIGS. 5B-5F represent non-limiting examples. Beginning with a first state (1) as shown in FIGS. 5A and 5B, the first amplitude of the first AC current of the first wire 110 is at 0, the second amplitude of the second AC of the second wire 210 current is at 10, and the direction of the magnetic field at a point above the area of overlap 300 may oscillate between the Y-axis direction and the negative Y-axis direction.

To rotate the magnetic field clockwise to a second position corresponding to a second state (2) as shown in FIGS. 5A and 5C, the first and second AC currents are driven in phase, the first amplitude is increased while the second amplitude is decreased until they are the same (each at an amplitude of 5), and the direction of the magnetic field at the point will oscillate between 45° between the X-axis direction and the Y-axis direction and 45° between the negative X-axis direction and the negative Y-axis direction.

To rotate the magnetic field clockwise to a third position corresponding to a third state (3) as shown in FIGS. 5A and 5D, the first and second AC currents are driven in phase, the first amplitude is increased while the second amplitude is decreased until the first amplitude is at 10 and the second amplitude is at 0, and the direction of the magnetic field at the point will oscillate between the X-axis direction and the negative X-axis direction.

To rotate the magnetic field to a fourth position corresponding to a fourth state (4) as shown in FIGS. 5A and 5E, the first and second AC currents are driven 180° out of phase, the first amplitude is decreased while the second amplitude is increased until the first and second amplitudes are the same (each at 5), and the direction of the magnetic field at the point will oscillate between 45° between the X-axis direction and the negative Y-axis direction and 45° between the negative X-axis direction and the Y-axis direction.

To rotate the magnetic field to a fifth position corresponding to a fifth state (5) as shown in FIGS. 5A and 5F, the first and second AC currents are driven 180° out of phase, the first amplitude is decreased while the second amplitude is increased until the first amplitude is at 0 and the second amplitude is at 10, and the direction of the magnetic field at the point may oscillate between the negative Y-axis direction and the Y-axis direction, similar to the first state (1). As used herein, the terms “first amplitude” and “second amplitude” refer to the peak amplitude.

Accordingly, the direction of the magnetic field at a point above the area of overlap 300 may be rotated to have any direction in the X-Y plane (any of quadrants I-IV of the X-Y plane in FIG. 5) by gradually adjusting the first amplitude of the first AC current and the second amplitude of the second AC current, and by shifting the first and second AC currents between being in-phase and being 180° out of phase. For example, when the first and second AC currents are in phase, the magnetic field at the point may have any direction in the first and third quadrants I and III of the X-Y plane by suitably setting the first and second amplitudes. Furthermore, when the first and second AC currents are 180° out of phase, the magnetic field at the point may have any direction in the second and fourth quadrants II and IV of the X-Y plane by suitably setting the first and second amplitudes.

Although a direction of the magnetic field generated by the wireless power transfer device 10 at a point above the area of overlap 300 has been described with respect to FIG. 5, it will be understood that the direction of the magnetic field at any point around the wireless power transfer device 10 may be controlled or selected (e.g., rotated) as described above by controlling the first and second amplitudes and by controlling the phase difference between the first and second AC currents. The direction of the magnetic field at points away from regions above or below the area of overlap 300 may have a directional component along the Z-axis direction, whereas a direction of the magnetic field at regions above or below the area of overlap 300 may have substantially no Z-axis component.

The wireless power transfer device 10 may also include a power source, such as a rechargeable battery (e.g., a lithium-ion battery pack) or non-rechargeable battery (e.g., a replaceable battery), or the wireless power transfer device 10 may be configured to couple to (e.g., connect to), and be powered from, an external power source, such an electrical outlet. In some embodiments, the wireless power transfer device 10 includes a rechargeable battery and a power management system. A charger profile of the rechargeable battery may be set to not perform trickle charging, and the rechargeable battery may be allowed to charge to a set percentage of battery state of charge (SoC) of the rechargeable battery, for example, a percentage within a range of about 80% to about 90% of the SoC. The SoC of the rechargeable battery may refer to the maximum charge that the rechargeable battery is able to store.

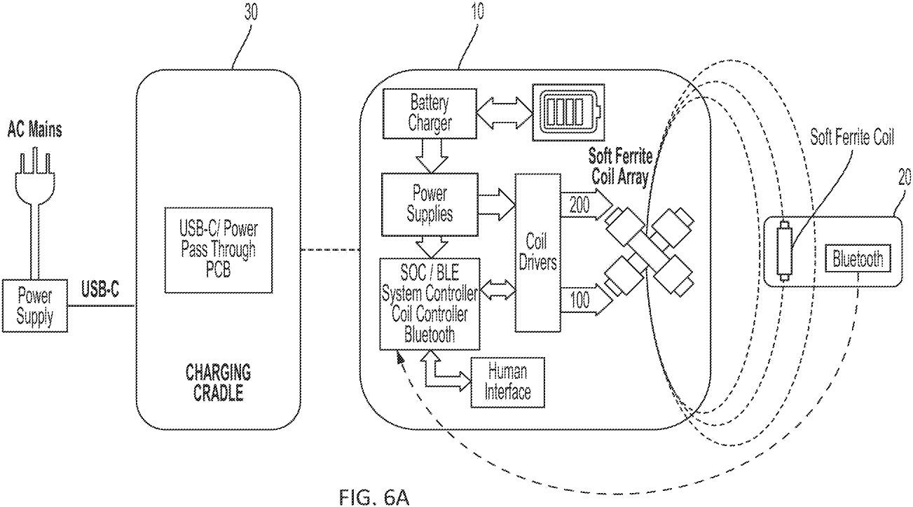

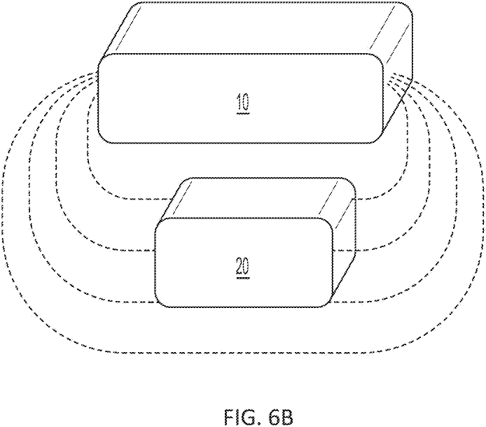

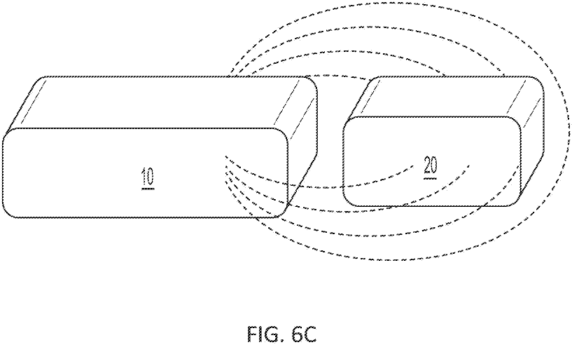

Referring to FIG. 6A, which illustrates a wireless power transfer system according to some embodiments, the rechargeable battery of the wireless power transfer device 10 may be recharged through a power port or connector of the wireless power transfer device 10 that interfaces with a charger cradle 30. The wireless power transfer device 10 may be configured to be placed in or fixed to the charger cradle 30, and the wireless power transfer device 10 may be configured to detect the presence of a voltage at the power port or connector when it is placed in or fixed to the charger cradle 30. In some embodiments, the wireless power transfer device 10 is configured to allow the rechargeable battery to charge when the detected voltage value is equal to a set value or within a set range.

Referring again to FIG. 1, the driver 400 may include a first driver 410 to drive the first transmitting coil 100 and a second driver 420 to drive the second transmitting coil 200. In some embodiments, each of the first and second drivers 410 and 420 include a class D MOSFET bridge module, and the first and second drivers 410 and 420 may be respectively coupled (e.g., connected) in series to the first and second wires 110 and 210 through a capacitor to create a series resonant tank circuit, which may be tuned to 125 kHz. At the tuned frequency, the circuit may have the lowest impedance and highest quality factor.

Each of the first and second drivers 410 and 420 may receive an independent digital output signal from a digital port of the controller 600. Each of the digital output signals may be a driver signal, for example, a 125 kHz frequency, 50% duty cycle square wave. The two independent digital output signals may allow phase shifting between the first and second AC currents.

Each of the first and second drivers 410 and 420 may include an isolation current sensor respectively coupled (e.g., connected) in series with the first and second wires 110 and 210. The isolation current sensors may be configured to convert a current passing through the first and second drivers 410 and 420 into a proportional voltage which is rectified and signal conditioned. The signal may then be routed to an analog port of the controller 600 to be utilized as current feedback.

In some embodiments, the power modulation electronics 500 includes first power modulation electronics 510 and second power modulation electronics 520. The first and second power modulation electronics 510 and 520 may be respectively configured to provide power to the first and second drivers 410 and 420. The first and second power modulation electronics 510 and 520 may be independently controlled by respective analog output control signals received from the controller 600. In some embodiments, each of the first and second power modulation electronics 510 and 520 includes a single-ended primary-inductor converter (SEPIC) DC-to-DC converter that is configured to step-up or step-down a system bus voltage received at an input and to output the stepped-up or stepped-down voltage.

Each of the first and second power modulation electronics 510 and 520 may be configured to monitor their respective output voltages and provide overcurrent protection. In some embodiments, the first and second power modulation electronics 510 and 520 are configured to attenuate their respective output voltages, filter their output voltages via a capacitor, and couple (e.g., connect) their output voltages to respective analog inputs of the controller 600. For example, the first and second power modulation electronics 510 and 520 may be configured to provide their respective output voltages to the controller 600 as analog voltage feedback signals. The controller 600 may be configured to then provide respective digital signals to the first and second power modulation electronics 510 and 520 to enable or disable the first and second power modulation electronics 510 and 520 from providing power to the first and second drivers 410 and 420.

In some embodiments, the controller 600 is a Bluetooth™ low energy system on chip controller (BLE SOC). The controller 600 may be programmed via a JTAG or USB-C connector. In some embodiments, the controller 600 is configured to provide two analog output control signals to the first and second power modulation electronics 510 and 520, and the controller 600 is configured to receive two analog voltage feedback signals from the first and second power modulation electronics 510 and 520, which are utilized to monitor and adjust output power and to detect supply faults. Furthermore, the controller 600 may be configured to provide two digital output signals to the first and second drivers 410 and 420 to drive the first and second transmitting coils 100 and 200, and the controller 600 may be configured to provide two digital output signals to enable or disable the first and second power modulation electronics 510 and 520. The two digital output signals may be wave pulses having a frequency and duty cycle, such as 125 kHz and 50% duty cycle.

The controller 600 may be configured to control the power output from each of the first and second drivers 410 and 420 by controlling the respective bus voltages of the first and second power modulation electronics 510 and 520. The controller 600 may also be configured to control the phase difference between the first and second AC currents by changing a phase difference between the digital output signal pulse signals it provides to the first and second drivers 410 and 420. Accordingly, by controlling the power of the first and second AC currents and the phase difference between the first and second AC currents, the controller 600 may control the direction and magnitude of the magnetic fields generated by the first and second transmitting coils 100 and 200.

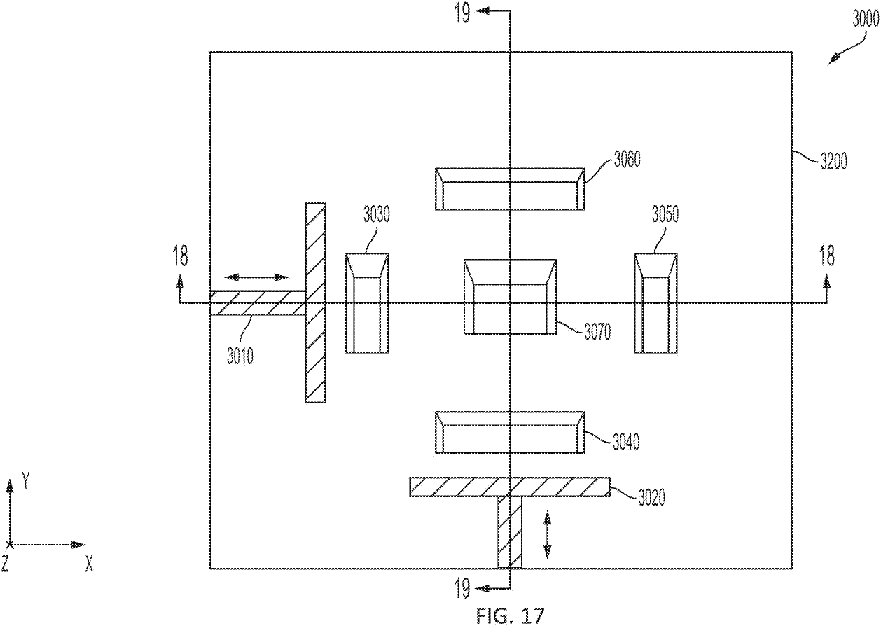

The wireless power transfer device 10 may be configured (e.g., via the controller 600) to communicate various suitable information to the user. Such information may include information about charging of the wireless power transfer device 10, information about charging of the electronic device 20, and various faults (e.g., defects, overheating, etc.). More details regarding what information the wireless power transfer device 10 may communicate to the user will be described below with reference to FIGS. 17-22. The wireless power transfer device 10 may communicate the information via any suitable means, for example, auditory signals, visual signals, and/or haptic feedback signals (e.g., vibrational signals). For example, referring to FIG. 6A, the wireless power transfer device 10 may include a human interface circuit that includes a piezoelectric based speaker, a vibration motor, and/or an LED light configured to communicate information.

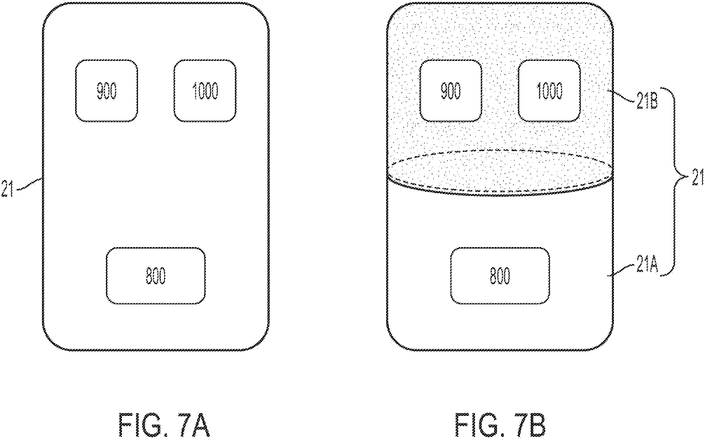

The electronic device 20 may be an implantable device (e.g., a device that is configured to be inserted in vivo). In some embodiments where the electronic device 20 is an implantable medical device, the electronic device 20 may include a casing 21 that encases the components of the electronic device 20. In some embodiments, as shown in FIG. 7A, the entire casing 21 may include a metallic material. In some other embodiments, as shown in FIG. 7B, a first portion 21A of the casing 21 may include a ceramic material and a second portion of 21B of the casing 21 may include a metallic material. The first portion 21A may cover the receiver coil 800, and the second portion 21B may cover the other components of the electronic device 20 (e.g., the detector 900 and the transmitter 950). The size and configuration of the first and second portions 21A and 21B may depend, for example, on the sizes, shapes, and relative positions of the receiver coil 800 and the other components of the electronic device 20. In some embodiments, a portion of the casing 21 may include a plastic, an epoxy, and/or a polymer material.

The electronic device 20 is not limited to implantable devices or medical devices, and the electronic device 20 may be any suitable device configured to receive power and/or generate an electrical current via electromagnetic induction. In some embodiments, the electronic device 20 may be configured to store energy of the current generated in the receiver coil 800, for example, in a capacitor. However, the present disclosure is not limited thereto, and the electronic device 20 may be configured in some embodiments to utilize the current without storing the energy of the current. For example, energy of the current generated in the receiver coil 800 may be utilized to drive or power other components in the electronic device 20.

When the electronic device 20 is in the proximity of the wireless power transfer device 10, and the wireless power transfer device 10 generates an oscillating magnetic field, a current may be generated in the receiver coil 800 by electromagnetic induction via the oscillating magnetic field. The receiver coil 800 may be, for example, a solenoid with a ferrimagnetic (e.g., soft ferrite) rod.

The detector 900 may be electrically coupled (e.g., electrically connected) to the receiver coil 800 and configured to detect information about the current (e.g., the power or amplitude of the current) generated in the receiver coil 800.

The transmitter 950 may be to transmit the information detected by the detector 900 to the receiver 700 of the wireless power transfer device 10, but the present disclosure is not limited thereto. The transmitter 950 may be configured to transmit the information to any suitable receiver outside of the electronic device 20 that is able to receive the information transmitted by the transmitter 950. In some embodiments, the transmitter 950 transmits information wirelessly, for example, via Bluetooth™ low energy (BLE).

Aligning the orientation of magnetic field at the receiver coil 800 with the receiver coil 800 increases the efficiency at which the wireless power transfer device 10 transfers power to the electronic device 20 compared to otherwise comparable wireless power transfer devices and receiver coils in which the magnetic field is misaligned. Accordingly, the wireless power transfer device 10 may rotate the magnetic field in order to align (e.g., optimally align) the magnetic field with the receiver coil 800.

A feedback system that monitors (e.g., directly or indirectly monitors) the relative direction of the magnetic field at the receiver coil 800 may be utilized to align (or to enable an operator to align) the magnetic field with the receiver coil 800. The feedback system may allow the wireless power transfer device 10 to automatically align the magnetic field with, or to create a magnetic field that is aligned with, the receiver coil 800 at the receiver coil 800 without requiring a user to manually adjust the position and/or orientation of the wireless power transfer device 10 after placing the wireless power transfer device 10 in proximity with the electronic device 20. Two example feedback systems will now be described in more detail.

In a first feedback system, the wireless power transfer device 10 generates an initial magnetic field and rotates the initial magnetic field (e.g., in the manner described above with reference to FIG. 5). As the initial magnetic field is rotated, the detector 900 detects information (e.g., power or amplitude) of the current generated in the receiver coil 800. The power received in the receiver coil 800 (e.g., the power of the current generated in the receiver coil 800) may correlate with how aligned the initial magnetic field is with the receiver coil 800. Accordingly, a maximum detected power may correspond to alignment (e.g., optimal alignment) between the initial magnetic field and the receiver coil 800. The maximum detected power also indicates what values of the first amplitude, the second amplitude, and the relative phase between the first and second AC currents generate a magnetic field that will be aligned with the receiver coil 800. After this information is obtained, the wireless power transfer device 10 may generate a magnetic field aligned with the receiver coil 800 to charge (or drive) the electronic device 20.

In a second feedback system, load modulation may be utilized. Load modulation is described in Griffith, U.S. Pat. No. 9,962,085 and Finkenzeller, “Battery Powered Tags for ISO/IEC 14443, Actively Emulating Load Modulation,” RFID SysTech 2011 7th European Workshop on Smart Objects: Systems, Technologies and Applications (2011), the entire content of each of which is incorporated herein by reference.

In the second feedback system, the wireless power transfer device 10 may generate an initial magnetic field and rotate the initial magnetic field (e.g., in the manner described above with reference to FIG. 5). The electronic device 20 may include a modulation resistance coupled (e.g., connected in parallel) to the receiver coil 800, and the modulation resistance can be turned on and off to cause the receiver coil 800 to transmit a signal back to the wireless power transfer device 10 while the electronic device 20 receives power from the wireless power transfer device 10. Information in the signal may be controlled or selected, for example, by the clock rate at which the modulation resistance is turned on and off. The signal may include information about how aligned (i.e., the degree or extent of alignment) the initial magnetic field is with the receiver coil 800. The signal may be measured by a demodulator in the wireless power transfer device 10 that is coupled to one or both of the first and second transmitting coils 100 and 200. The information in the signal may be utilized to determine what values of the first amplitude, the second amplitude, and the relative phase between the first and second AC currents generate a magnetic field that will be aligned with the receiver coil 800. After this information is obtained, the wireless power transfer device 10 may generate a magnetic field that is aligned with the receiver coil 800 to charge (or drive) the electronic device 20.

In some embodiments, the values of the first amplitude, the second amplitude, and the phase difference between the first and second AC currents that can generate a magnetic field that is aligned with the receiver coil 800 may be determined after the wireless power transfer device 10 rotates the magnetic field through a range of degrees (e.g., the wireless power transfer device 10 sweeps the magnetic field through a range of orientations), for example, a full 180° sweep (360° when taking into account the oscillating nature of the magnetic field), but the present disclosure is not limited thereto. For example, information regarding how aligned the initial magnetic field is with the receiver coil 800 may be continuously monitored, and the wireless power transfer device 10 (e.g., the controller 600 of the wireless power transfer device 10) may stop the rotation when alignment (e.g., optimal alignment) between the initial magnetic field and the receiver coil 800 has been detected. The wireless power transfer device 10 may then charge (or drive) the electronic device 20.

The wireless power transfer device 10 may be configured to transfer power to the electronic device 20 regardless of where the electronic device 20 is positioned relative to the wireless power transfer device 10. For example, FIGS. 6B and 6C show schematic side views of the wireless power transfer device 10 and electronic device 20 of the wireless power transfer system of FIG. 6A with the electronic device 20 in two different positions relative to the wireless power transfer device 10. For example, FIGS. 6B and 6C show side views of a plane substantially defined by the first and second transmitting coils 100 and 200. FIG. 6B shows a non-limiting example where the wireless power transfer device 10 transfers power to the electronic device 20 while being positioned above (e.g., while an area of overlap between the first and second transmitting coils 100 and 200 is positioned above) the electronic device 20. FIG. 6C shows a non-limiting example where the wireless power transfer device 10 transfers power to the electronic device while the electronic device 20 is positioned at the side of the wireless power transfer device 10 (e.g., at the side of the first and second transmitting coils 100 and 200).

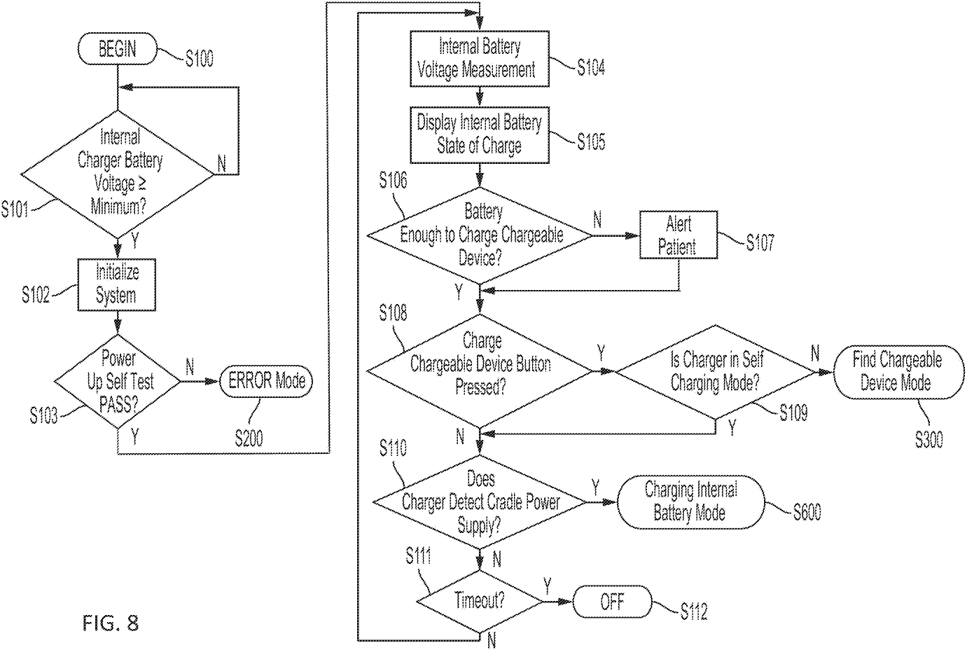

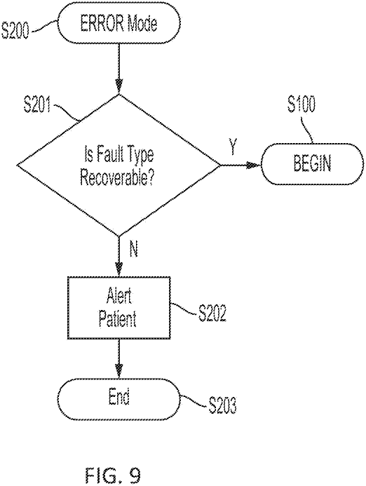

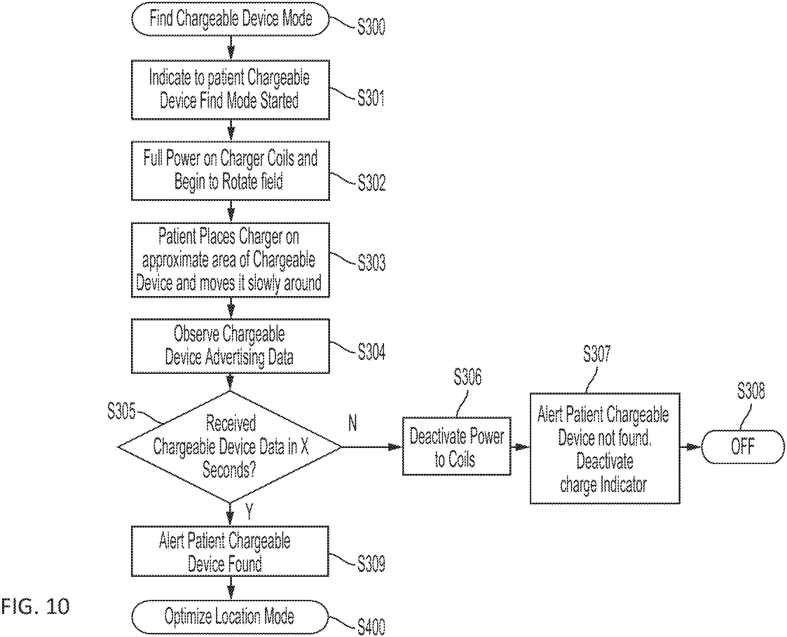

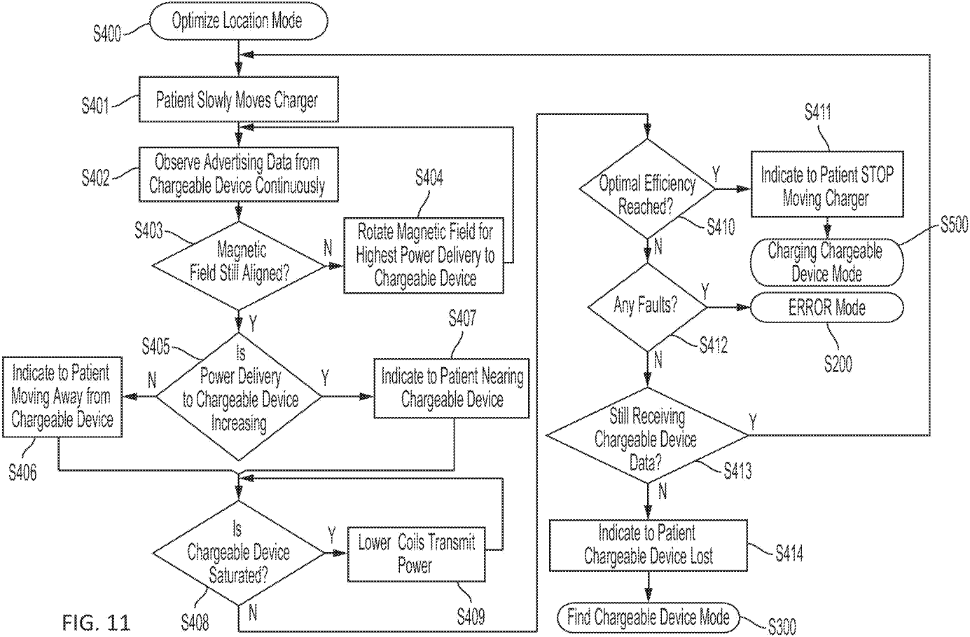

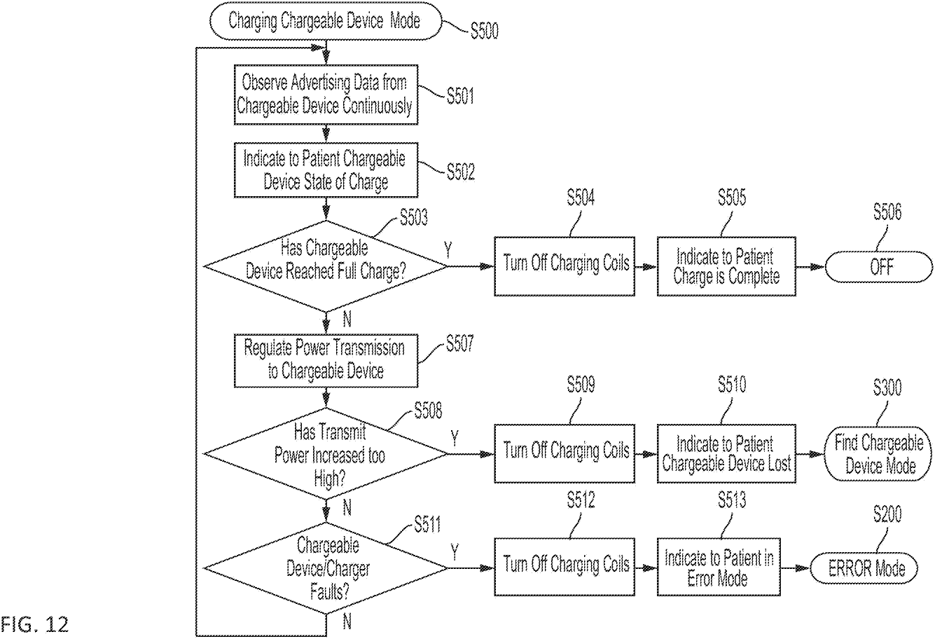

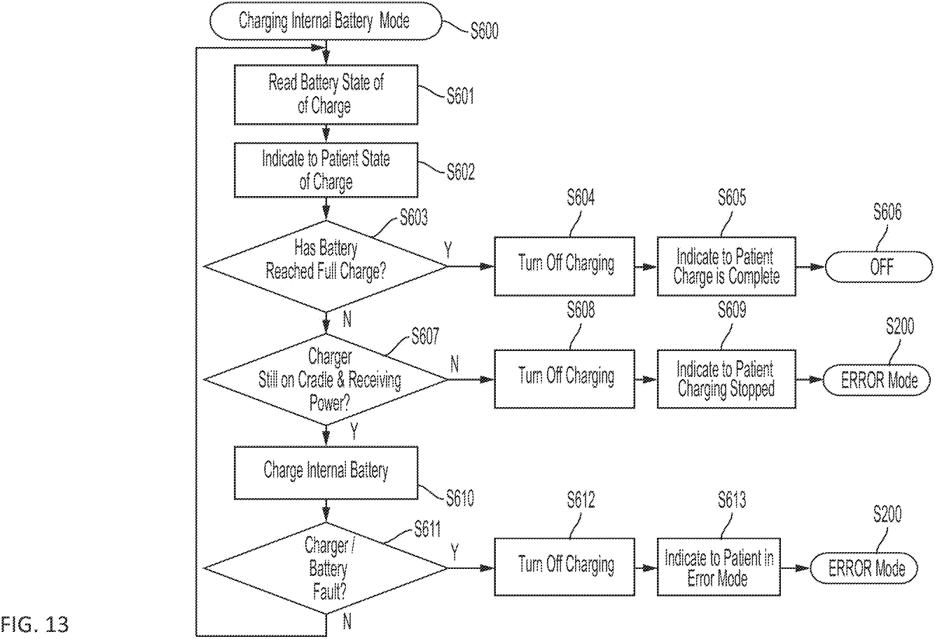

Various modes of operating a wireless power transfer system will now be described in more detail with reference to FIGS. 8-13. FIG. 8 illustrates an initialization mode; FIG. 9 illustrates an error mode; FIG. 10 illustrates a find the electronic device mode; FIG. 11 illustrates an optimize location mode; FIG. 12 illustrates an electronic device charging mode; and FIG. 13 illustrates a wireless power transfer device charging mode.

Referring to FIG. 8, an Initialization mode may begin at stage S100. The initialization mode may begin, for example, when the wireless power transfer device 10 is placed in the charger cradle 30, when a charge button is pressed, or when the wireless power transfer device 10 is trying to recover from a recoverable error. The charge button may be a button on the wireless power transfer device 10 that allows a user to initialize the wireless power transfer device 10 for charging the electronic device 20.

At stage S101, the wireless power transfer device 10 may determine whether a voltage of an internal battery (e.g., a rechargeable battery) of the wireless power transfer device 10 is greater than or equal to a minimum voltage. When the voltage of the internal battery is less than the minimum voltage, then the wireless power transfer device 10 may repeat stage S101. However, when the voltage of the internal battery is greater than or equal to the minimum voltage, the wireless power transfer device 10 may initialize the system of the wireless power transfer device 10 at stage S102.

After the wireless power transfer device 10 is initialized at stage S102, the wireless power transfer device 10 may perform a power up self-test at stage S103. For example, the wireless power transfer device 10 may test for internal faults (e.g., defects) or errors during stage S103, and the wireless power transfer device 10 may begin an error mode at stage S200 when the wireless power transfer device 10 detects an error such that the power up self-test fails. However, when at stage S103 the power up self-test is passed, the wireless power transfer device 10 may measure a voltage of the internal battery at stage S104 and communicate to the user the SoC of the internal battery at stage S105.

At stage S106, the wireless power transfer device 10 may determine whether the SoC of the internal battery is sufficient to charge (or drive) the electronic device 20. When the SoC of the internal battery is insufficiently low, the wireless power transfer device 10 may alert the user at S107 and proceed to stage S108. However, when at stage S106 the SoC is determined to be sufficient, the wireless power transfer device 10 may determine whether the charge button has been pressed at stage S108.

When the charge button has been pressed, the wireless power transfer device 10 may determine whether it is in a self-charging mode at stage S109. When the wireless power transfer device 10 is not in the self-charging mode, then the wireless power transfer device 10 may begin the find electronic device mode at stage S300. However, when at stage S109 the wireless power transfer device 10 is in the self-charging mode, the wireless power transfer device 10 may proceed to stage S110. Furthermore, when at stage S108 it is determined that the charge button has not been pressed, the wireless power transfer device 10 may detect whether a power supply from the charger cradle 30 is available.

When the wireless power transfer device 10 detects the power supply from the charger cradle 30, the wireless power transfer device 10 may begin the wireless power transfer device charging mode at stage S600. However, when at stage S110 the wireless power transfer device 10 does not detect the power supply from the charger cradle 30, the wireless power transfer device 10 may determine at stage S111 whether a set (e.g., predetermined) amount of time has passed since a previous stage, for example, stage S102 or stage S103.

When the wireless power transfer device 10 determines that the set amount of time has not elapsed, then the wireless power transfer device 10 may proceed to stage S104. However, when the set amount of time has elapsed, then the wireless power transfer device 10 may turn off at stage S112.

Referring to FIG. 9, after the error mode begins at stage S200, the wireless power transfer device 10 may determine at stage S201 whether it is able to recover from (e.g., resolve or remedy) the fault. When the wireless power transfer device 10 is able to recover from the fault, the wireless power transfer device 10 may begin the initialization mode at stage S100. However, when the wireless power transfer device 10 is unable to recover from the fault, the wireless power transfer device 10 may alert the user at stage S202 that the wireless power transfer device 10 is unable to recover. The wireless power transfer device 10 may then end the error mode at stage S203. In some embodiments, the wireless power transfer device 10 may turn off at stage S203.

Referring to FIG. 10, after the find electronic device mode begins at stage S300, the wireless power transfer device 10 may communicate to the user that the find electronic device mode has started. The wireless power transfer device 10 may drive the first and second transmitting coils 100 and 200 to generate and rotate an initial magnetic field at stage S302. At stage S303, the wireless power transfer device 10 may be placed at an initial position in approximate or estimated proximity to the electronic device 20, and the wireless power transfer device 10 may be moved slowly around the initial position. At stage S304, the wireless power transfer device 10 may communicate information to the user regarding whether the electronic device 20 has been located, for example, by receiving a signal from the electronic device 20, while the wireless power transfer device 10 is moved around the initial position.

The wireless power transfer device 10 may determine at stage S305 whether the electronic device 20 has been located within a set amount of time, for example, from a previous stage such as S303. When the electronic device 20 has not been located when the set amount of time elapses, the wireless power transfer device 10 may stop driving the first and second transmitting coils 100 and 200 to terminate the initial magnetic field at stage S306. The wireless power transfer device 10 may then communicate to the user that the electronic device 20 was not found at stage S307, and the wireless power transfer device 10 may turn off at stage S308. However, when at stage S305 the wireless power transfer device 10 determines within the set amount of time that the electronic device 20 has been found, then the wireless power transfer device 10 may communicate to the user that the electronic device 20 has been found at stage S309. The wireless power transfer device 10 may then begin an optimize location mode at stage S400.

Referring to FIG. 11, after the optimize location mode begins at stage S400 and at stage S401, the wireless power transfer device 10 may be slowly moved, for example, from a second position where the wireless power transfer device 10 was located when the electronic device 20 was found. The wireless power transfer device 10 may continuously communicate information to the user at stage S402 while the wireless power transfer device 10 is being moved. The information communicated at stage S402 may include whether the initial magnetic field is aligned with the receiver coil 800 and whether power delivered to the electronic device 20 is increasing or decreasing. The wireless power transfer device 10 may determine whether the initial magnetic field is aligned with the receiver coil 800 by utilizing a feedback system as described above.

At stage S403, the wireless power transfer device 10 may determine whether the initial magnetic field is aligned with the receiver coil 800. When the initial magnetic field is not aligned, the wireless power transfer device 10 may rotate the initial magnetic field as needed (e.g., by utilizing a feedback system as described above) at stage S404 to automatically align the initial magnetic field with the receiver coil 800. However, when at stage S403 the wireless power transfer device 10 determines that the initial magnetic field is aligned with the receiver coil 800, then the wireless power transfer device 10 may determine at stage S405 whether power delivered to the electronic device 20 is increasing as the wireless power transfer device 10 is moved. The wireless power transfer device 10 may then communicate to the user whether the wireless power transfer device 10 is being moved away from the electronic device 20 (stage S406) or toward the electronic device 20 (stage S407).

At stage S408, the wireless power transfer device 10 may determine whether the receiver coil 800 is saturated. Saturation of the receiver coil 800 may occur when an increase in magnitude of the initial magnetic field at the receiver coil 800 does not significantly increase the magnetization of the rod material (e.g., ferrimagnetic material) of the receiver coil 800. When it is determined that the receiver coil 800 is saturated, the first and second amplitudes of the first and second currents utilized to generate the initial magnetic field may be reduced at stage S409, and the wireless power transfer device 10 may again determine whether the receiver coil 800 is saturated at stage S408. However, when at stage S408 it is determined that the receiver coil 800 is not saturated, the wireless power transfer device 10 may determine whether the wireless power transfer device 10 is at an optimal position and/or orientation at stage S410. The optimal position and/or orientation may correspond to a position and/or orientation of the wireless power transfer device 10 that results in a maximum power received in the receiver coil at set amplitudes of the first and second AC currents that do not saturate the receiver coil 800.

When it is determined that the wireless power transfer device 10 is at an optimal position and/or orientation, the wireless power transfer device 10 may communicate to the user to stop moving the wireless power transfer device 10 at stage S411, and the wireless power transfer device 10 may begin the electronic device charging mode at stage S500. However, when at stage S410 it is determined that the wireless power transfer device 10 is not at an optimal position and/or orientation, the wireless power transfer device 10 may conduct a test to detect faults at stage S412. When a fault is detected, the wireless power transfer device 10 may begin the error mode at stage S200. However, when no faults are detected, the wireless power transfer device 10 may determine whether information from the electronic device 20 is still being received at stage S413.

When information from the electronic device 20 is still being received, the user may continue to move the wireless power transfer device 10 at stage S401. For example, the wireless power transfer device 10 may prompt the user to continue to move the wireless power transfer device 10. However, when at stage S413 the wireless power transfer device 10 determines that information is not being received from the electronic device 20, the wireless power transfer device 10 may communicate to the user at stage S414 that the electronic device 20 has been lost, and the wireless power transfer device 10 may begin the find electronic device mode at stage S300.

Referring to FIG. 12, after the electronic device charging mode begins at stage S500, information from the electronic device 20 may be continuously received and monitored at stage S501, and the wireless power transfer device 10 may communicate information about the electronic device 20 (e.g., SoC of a battery or of an energy storage in the electronic device 20) to the user at stage S502.

At stage S503, the wireless power transfer device 10 may determine whether the electronic device 20 has reached a set SoC of the electronic device 20. For example, the wireless power transfer device 10 may determine whether the electronic device 20 has reached a fully charged state. When the electronic device 20 has reached the set SoC, the wireless power transfer device 10 may stop driving the first and second transmitting coils 100 and 200 at stage S504 to terminate the magnetic field generated by the wireless power transfer device 10. The wireless power transfer device 10 may then communicate to the user that the charge is complete at stage S505 before turning off at stage S506.

However, when at stage S503 the wireless power transfer device 10 determines that the set SoC of the electronic device 20 has not been reached, it may regulate power transmission to the electronic device 20 at stage S507. For example, the wireless power transfer device 10 may change the amplitudes of the first and second AC currents to reduce or increase the power provided to the electronic device 20.

At stage S508, the wireless power transfer device 10 may determine whether transmission power is at or above a set or predetermined threshold. When the transmission power is at or above the set or predetermined threshold, the wireless power transfer device 10 may turn off the first and second transmitting coils 100 and 200 at stage S509 to terminate the magnetic field. The wireless power transfer device 10 may then communicate to the user that the electronic device 20 has been lost at stage S510 and begin the find electronic device mode at stage S300.

However, when at stage S508 the wireless power transfer device 10 determines that the transmission power is below the set or predetermined threshold, then the wireless power transfer device 10 may determine whether any faults have occurred in the wireless power transfer device 10 and/or in the electronic device 20 at stage S511. When a fault is detected, the wireless power transfer device 10 may turn off the first and second transmitting coils 100 and 200 at stage S512. The wireless power transfer device 10 may then communicate to the user that a fault has been found and begin the error mode at stage S200.

However, when at stage S511 the wireless power transfer device 10 does not detect any faults, the wireless power transfer device 10 may proceed to stage S501 and continue to receive and monitor information received from the electronic device 20.

Referring to FIG. 13, the wireless power transfer device 10 may begin charging an internal battery via a power supply provided by the charger cradle 30 at stage S600 of the wireless power transfer device charging mode. The wireless power transfer device 10 may determine a SoC of the internal battery at stage S601 and communicate the SoC to the user at stage S602. At stage S603, the wireless power transfer device 10 may determine whether a set SoC of the internal battery has been reached. For example, the wireless power transfer device 10 may determine whether the internal battery has been fully charged.

When the wireless power transfer device 10 determines that the set SoC of the internal battery has been reached, the wireless power transfer device 10 may stop charging the internal battery at stage S604, communicate to the user that the charging process is complete at stage S605, and turn off at stage S606.

However, when at stage S603 the wireless power transfer device 10 determines that the internal battery has not reached the set SoC, the wireless power transfer device 10 may determine whether the wireless power transfer device 10 is still coupled to (e.g., on or in) the charger cradle 30 and receiving power from the charger cradle 30. When the wireless power transfer device 10 is not coupled to the charger cradle 30 or not receiving power from the charger cradle 30, the wireless power transfer device 10 may stop charging the internal battery at stage S608, communicate to the user that the charging process has stopped at stage S609, and begin the error mode at stage S200.

However, when at stage S607 the wireless power transfer device 10 determines that the wireless power transfer device 10 is coupled to the charger cradle 30 and is receiving power from the charger cradle 30, the wireless power transfer device 10 may continue to charge the internal battery at stage S610. At stage S611, the wireless power transfer device 10 may determine whether faults have occurred in the wireless power transfer device 10 and/or in the internal battery at stage S611. When a fault is detected, the wireless power transfer device 10 may stop the charging process at stage S612, communicate to the client that the charging process has stopped at stage S613, and begin the error mode at stage S200.

However, when at stage S611 the wireless power transfer device 10 does not detect any faults, the wireless power transfer device 10 may proceed to stage S601 to determine the SoC of the internal battery.

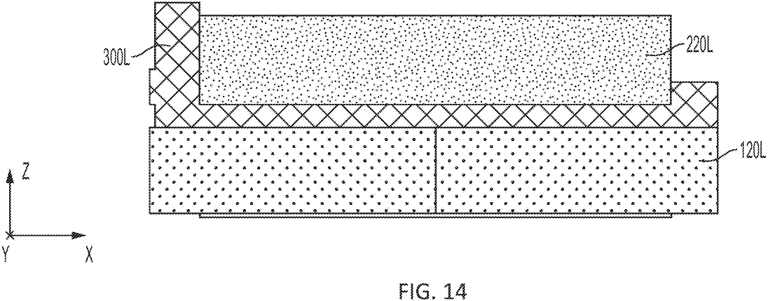

FIG. 14 shows a cross-sectional view of a part of a wireless power transfer device according to some embodiments. Referring to FIGS. 1, 2, and 14, the first rod 120 may include (e.g., be) a first magnetic layer 120L of a solid magnetic material, the second rod 220 may include (e.g., be) a second magnetic layer 220L of a solid magnetic material, and the nonmagnetic material in the intermediate space 300a may include (e.g., be) nonmagnetic layer 300L of a solid nonmagnetic material.

In some embodiments, the first magnetic layer 120L, the nonmagnetic layer 300L, and/or the second magnetic layer 220L may each have uniform (e.g., substantially uniform) thicknesses (e.g., along the Z-axis direction as shown in FIG. 14), but the present disclosure is not limited thereto. For example, in some embodiments the first magnetic layer 120L may include a first region having a thickness corresponding to the thickness of the first main rod 120a and a second region having a thickness corresponding to the thickness of the first thick portion 120b, and/or the second magnetic layer 220L may include a first region having a first thickness corresponding to the thickness of the second main rod 220a and a second region having a thickness corresponding to the thickness of the second thick portion 220b (see FIG. 2). In some embodiments, as shown in FIG. 14, the nonmagnetic layer 300L may include thicker portions at sides of the second magnetic layer 220L that protrude upward in the Z-axis direction, which may restrict movement of the second magnetic layer 220L along the X-axis direction. In some embodiments, the nonmagnetic layer 300L may include other thicker portions at sides of the first magnetic layer 120L that protrude downward in the negative Z-axis direction, which may restrict movement of the first magnetic layer 120L along the Y-axis direction.

One or both of the first and second magnetic layers 120L and 220L may include (e.g., be) ferrite. In some embodiments, one or both of the first and second magnetic layers 120L and 220L may be pure ferrite. In other embodiments, one or both of the first and second magnetic layers 120L and 220L may include ferrite and one or more other components, such as a binder material. The ferrite may be included, for example, in at least 50 wt%, 60 wt%, 70 wt%, 80 wt%, 90 wt%, 93 wt%, 95 wt%, 97 wt%, or 99 wt%. The binder material may be an organic binder material and/or an inorganic binder material. The binder may be included, for example, in less than or equal to 50 wt, 40 wt%, 30 wt%, 20 wt%, 10 wt%, 7 wt%, 5 wt%, 3 wt%, or 1 wt%.

The nonmagnetic layer 300L may include (e.g., be) a nonmagnetic material. In some embodiments, the nonmagnetic layer 300L may include a nonmagnetic material and at least one binder material, such as an organic binder material and/or an inorganic binder material.

In some embodiments, the wireless power transfer device 10 may be at least partially (e.g., entirely) fabricated utilizing additive manufacturing (3D printing). For example, the nonmagnetic layer 300L and one or both of the first and second magnetic layers 120L and 220L may be fabricated utilizing additive manufacturing. Any additive manufacturing apparatus disclosed herein may be utilized to fabricate all or part of the wireless power transfer device 10.

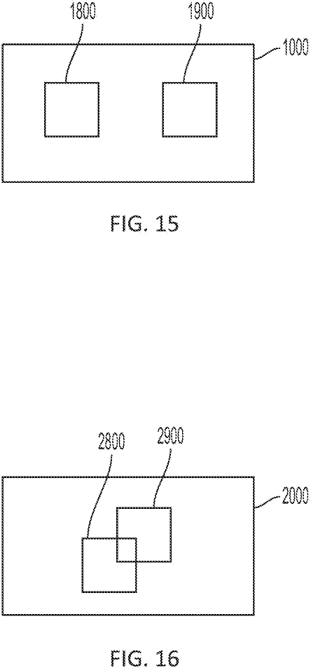

FIG. 15 shows a schematic diagram of an additive manufacturing apparatus according to some embodiments. FIG. 16 shows a schematic diagram of an additive manufacturing apparatus according to some embodiments.

Referring to FIG. 15, an additive manufacturing apparatus 1000 may include a magnetic material fabrication structure 1800 (e.g., a ferrite material fabrication structure) and a nonmagnetic material fabrication structure 1900. The magnetic material fabrication structure 1800 includes a first set of components configured to additive fabricate a layer of magnetic material (e.g., the first magnetic layer 120L and/or the second magnetic layers 220L) from a magnetic material precursor (e.g., a ferrite material precursor, such as ferrite crystals), and the nonmagnetic material fabrication structure 1900 includes a second set of components configured to additive fabricate a layer of nonmagnetic material (e.g., the nonmagnetic layer 300L) from a nonmagnetic material precursor. In the additive manufacturing apparatus 1000, the first and second sets of components do not share any common components.

Referring to FIG. 16, an additive manufacturing apparatus 2000 may include a magnetic material fabrication structure 2800 (e.g., a ferrite material fabrication structure) including a first set of components configured to additive fabricate a layer of magnetic material (e.g., the first magnetic layer 120L and/or the second magnetic layer 220L) from a magnetic material precursor (e.g., a ferrite material precursor), and a nonmagnetic material fabrication structure 2900 including a second set of components configured to additive fabricate a layer of nonmagnetic material from a nonmagnetic material precursor. In the additive manufacturing apparatus 2000, the first and second sets of components at least partially overlap so that one or more components included in the first set of components are also included in the second set of components.

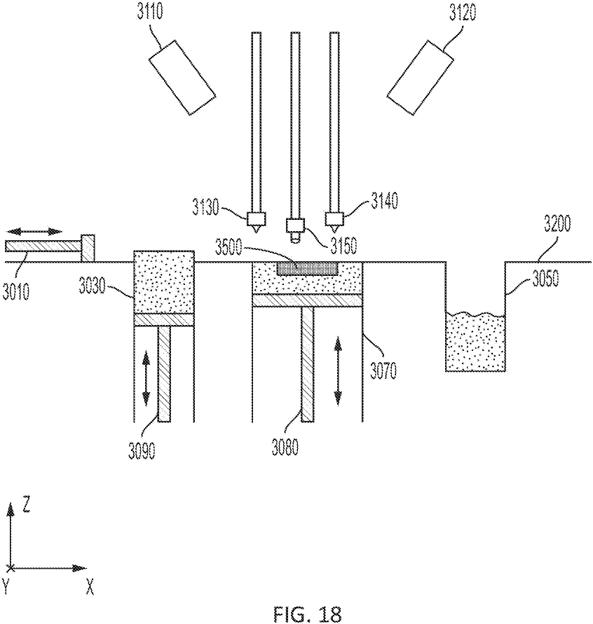

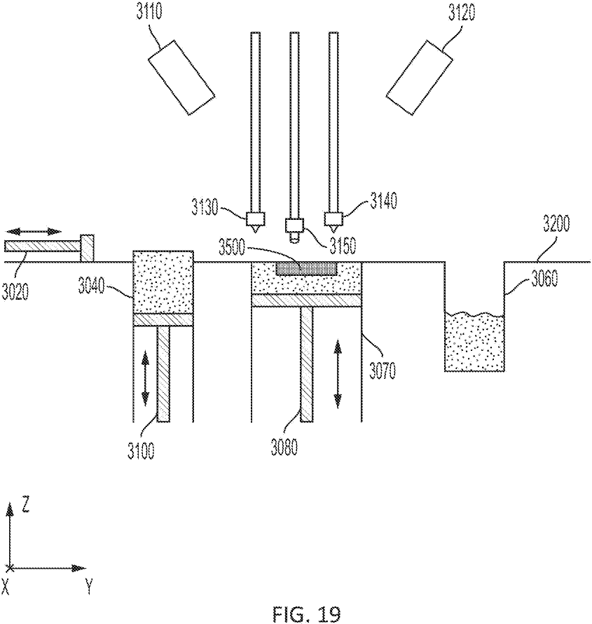

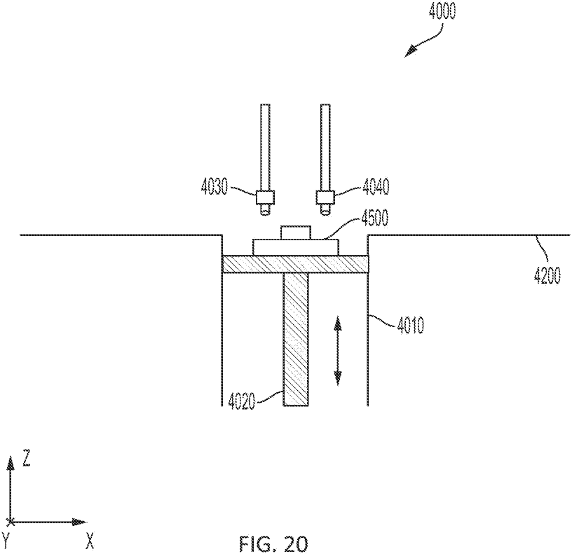

FIG. 17 shows a top view of a portion of an additive manufacturing apparatus according to some embodiments. FIG. 18 shows a schematic cross-sectional view along line 18-18 of the part of the additive manufacturing apparatus of FIG. 17, along with other components of the additive manufacturing apparatus of FIG. 17, according to some embodiments. FIG. 19 shows a schematic cross-sectional view along line 19-19 of the part of the additive manufacturing apparatus of FIG. 17, along with other components of the additive manufacturing apparatus of FIG. 17, according to some embodiments. FIGS. 20-22 show schematic cross-sectional views of additive manufacturing apparatuses according to some embodiments. Each of the additive manufacturing apparatuses of FIGS. 17-22 includes a magnetic material fabrication structure and a nonmagnetic material fabrication structure according to the additive manufacturing apparatus of FIG. 15 or of FIG. 16.

Referring to FIGS. 17-19, an additive manufacturing apparatus 3000 according to some embodiments includes a frame 3200, a powder bed chamber 3070 in the frame 3200, and a movable build platform 3080 configured to move up and down (e.g., along the Z-axis direction) inside of the powder bed chamber 3070.

The additive manufacturing apparatus 3000 includes a first powder delivery system including a first powder reservoir 3030 in the frame 3200 and to contain a first powder including a magnetic material precursor (e.g., ferrite material precursor), a first movable powder platform 3090 configured to move up and down (e.g., along the Z-axis) inside the first powder reservoir 3030 to deliver the first powder to a top surface of the frame 3200, and a first leveling mechanism 3010 on the top surface of the frame 3200 and configured to move a portion of the first powder along the top surface of the frame 3200 into the powder bed chamber 3070. For example, the first leveling mechanism 3010 may be configured to move along the X-axis direction, as shown. A first powder overflow reservoir 3050 may be in the frame 3200 and positioned so that the first leveling mechanism 3010 pushes excess amounts of the first powder into the first powder overflow reservoir 3050 to avoid buildup of the first powder during operation of the additive manufacturing apparatus 3000. The first powder delivery system and the first powder overflow reservoir 3050 are shown in the cross-sectional view of FIG. 18.

The additive manufacturing apparatus 3000 includes a second powder deliver system including a second powder reservoir 3040 in the frame 3200 and to contain a second powder including a nonmagnetic material precursor, a second movable powder platform 3100 configured to move up and down (e.g., along the Z-axis) inside the second powder reservoir 3040 to deliver the second powder to the top surface of the frame 3200, and a second leveling mechanism 3020 on the top surface of the frame 3200 and configured to move the second powder along the top surface of the frame 3200 into the powder bed chamber 3070. For example, the second leveling mechanism 3020 may be configured to move along the Y-axis direction, as shown. A second powder overflow reservoir 3060 may be in the frame 3200 and positioned so that the second leveling mechanism 3020 pushes excess amounts of the second powder into the second powder overflow reservoir 3060 to avoid buildup of the second powder during operation of the additive manufacturing apparatus 3000. The second powder delivery system and the second powder overflow reservoir 3060 are shown in the cross-sectional view of FIG. 19.

During operation of the additive manufacturing apparatus 3000, the first and second powder delivery systems can each deliver a layer of powder to the powder bed chamber 3070, and the layer of powder can be processed according to any of the processes described herein to join one or more regions of the powder layer. Then another layer of powder can be delivered to the powder bed chamber 3070 on the processed layer, and the other layer may be processed in a similar manner. By processing multiple layers, a solid component can be at least partially fabricated. Feature 3500 illustrates a component being fabricated utilizing the additive manufacturing apparatus 3000. Furthermore, because the additive manufacturing apparatus 3000 includes both the first and second powder delivery systems, the solid component may be fabricated with one or more magnetic parts and one or more nonmagnetic parts.

For example, a first plurality of layers of the first powder may be provided and processed in the powder bed chamber 3070 to form the first magnetic layer 120L, a plurality of layers of the second powder may be provided and processed in the powder bed chamber 3070 to form the nonmagnetic layer 300L, and a second plurality of layers of the first powder may be provided and processed in the powder bed chamber 3070 to form the second magnetic layer 220L. Accordingly, the first magnetic layer 120L, the nonmagnetic layer 300L, and the second magnetic layer 220L may be fabricated utilizing a single additive manufacturing apparatus in a seamless process.

In some embodiments, the additive manufacturing apparatus 3000 includes only one selected from the first and second powder delivery systems, and the other one selected from the first and second powder delivery systems is omitted.

In some other embodiments, the second leveling mechanism is 3020 is omitted and the first leveling mechanism 3010 is configured to provide both the first and second powders to the powder bed chamber 3070. For example, the first powder reservoir 3030, the second powder reservoir 3040, and the powder bed chamber 3070 may be arranged (e.g., may be arranged in this order) with each other along a line (e.g., along line 18-18 or line 19-19) in the frame 3200, and the first leveling mechanism 3010 may be configured to move along the line to provide the first powder to the powder bed chamber 3070 and to provide the second powder to the powder bed chamber 3070. In some other embodiments, the first powder reservoir 3030 and the powder bed chamber 3070 are arranged with each other along a first line in the frame 3200 (e.g., line 18-18), the second powder reservoir 3040 and the powder bed chamber 3070 are arranged with each other along a second line in the frame 3200 (e.g., line 19-19), and the first leveling mechanism 3010 is configured to be controllably rotated around at least part of the frame 3200 (e.g., around an outer region of the frame 3200) so that it can selectively move translationally along the first line or along the second line.

Referring to FIGS. 18 and 19, the additive manufacturing apparatus 3000 may include one or more (e.g., all) of a first laser 3110, a second laser 3120, a first binder printhead 3130, a second binder printhead 3140, and an extrusion nozzle 3150.

The first laser 3110 may be a scanning laser configured to direct a laser beam at multiple positions over a powder layer in the powder bed chamber 3070. For example, the first laser 3110 may be configured to direct the laser beam over a planar region of the powder layer parallel to the X-Y plane. In some embodiments, the first laser 3110 may include a laser source and a scanner coupled to the laser source. The first laser 3110 may be configured to provide the laser beam at a single power or may be configured to vary the power of the laser beam. Accordingly, the first laser 3110 may be configured to sinter the first powder, to melt the first powder, to sinter the second powder, and/or to melt the second powder.

The second laser 3120 may be configured in any manner that the first laser 3110 may be configured in, and the second laser 3120 may have a configuration that is the same or different as the configuration of the first laser 3110. In some embodiments, the first laser 3110 is configured to sinter or melt the first powder and the second laser 3120 is configured to sinter or melt the second powder. In some other embodiments, the second laser 3120 is omitted, and the first laser 3110 is configured to sinter or melt the first powder and/or to sinter or melt the second powder.

Accordingly, the first laser 3110 and/or the second laser 3120 may be utilized to fabricate the first magnetic layer 120L, the nonmagnetic layer 300L, and/or the second magnetic layer 220L.

The first binder printhead 3130 may be configured to spray or provide droplets of a binder onto a powder layer in the powder bed chamber 3070. The binder may permeate through a portion of the powder layer, causing the powder to solidify. In some embodiments, the binder is a glue. The first binder printhead 3130 may be configured to be moved to multiple positions over the powder bed chamber 3070 and a powder layer therein. For example, the first binder printhead 3130 may be configured to be moved over a planar region of the powder layer parallel to the X-Y plane. In some embodiments, the first binder printhead 3130 is attached to an end of an arm (e.g., a robotic arm), and the first binder printhead 3130 is configured to be moved by the arm over the planar region. For example, one end of the arm may be attached to the first binder printhead 3130 and another end of the arm may be attached to a platform above the powder bed chamber 3070 and configured to move the arm (and thus the first binder printhead 3130) in each of the X-axis and Y-axis directions. In some embodiments, the first binder printhead 3130 may be configured to be moved (e.g., via the arm and/or the platform) in the Z-axis direction. The arm may also include a channel configured to provide the binder to the first binder printhead 3130.

The second binder printhead 3140 may be configured in any manner that the first binder printhead 3130 may be configured in, and the second binder printhead 3140 may have a configuration that is the same as or different from the configuration of the first binder printhead 3130. In some embodiments, the first and second binder printheads 3130 and 3140 are independently movable over powder ped chamber 3070 and a powder layer therein. In some other embodiments, the first and second binder printheads 3130 and 3140 are coupled together to be moved together.

In some embodiments, the first binder printhead 3130 is configured to spray or provide droplets of a first binder to the first powder, and the second binder printhead 3140 is configured to spray or provide droplets of a second binder to the second powder. In some other embodiments, the second binder printhead 3140 is omitted and the first binder printhead 3130 is configured to spray or provide droplets of a first binder to each of the first and second powders. In some other embodiments, the second binder printhead 3140 is omitted, and the first binder printhead 3130 is configured to spray or provide droplets of a binder to only one of the first and second powders, and the other one of the first and second powders may be processed by other means, such as sintering or melting by the first laser 3110.

In some other embodiments, the second binder printhead 3140 is omitted, and the first binder printhead 3130 is configured to separately and selectively spray or provide droplets of a first binder and a second binder. For example, an arm may be attached to the first binder printhead 3130 and include a first channel configured to provide the first binder to the first binder printhead 3130 and a second channel configured to provide the second binder to the first binder printhead. The first binder printhead 3130 may be configured to selectively receive one of the first binder or the second binder, for example, by being selectively coupled to one selected from the first and second channels and by being decoupled from the other one of the first and second channels. Accordingly, in such embodiments, the first binder printhead 3130 may be configured to provide the first binder to the first powder and to provide the second binder to the second powder.

The extrusion nozzle 3150 is configured to provide a composition including one selected from the magnetic precursor material and the nonmagnetic precursor material. The composition may also include a binder. The composition may have a relatively high viscosity, and the size (e.g., breadth, diameter, cross-sectional area) of an opening of the extrusion nozzle 3150 may be suitably large to allow the composition to be provided through the opening. In some embodiments, the composition is a paste or a solid filament. As used herein, an extrusion nozzle is not an inkjet nozzle, which one of ordinary skill in the art will understand to be a nozzle having an opening having a size configured to provide only compositions having viscosities lower than compositions that can be provided by an extrusion nozzle.

The extrusion nozzle 3150 may be configured to be moved to multiple positions over the powder bed chamber 3070 and the powder layer therein. For example, the extrusion nozzle 3150 may be configured to be moved over a planar region parallel to the X-Y plane over the power layer. In some embodiments, the extrusion nozzle 3150 is attached to an end of an arm (e.g., a robotic arm) configured to move the extrusion nozzle 3150 over the planar region. For example, one end of the arm may be attached to the extrusion nozzle 3150 and another end of the arm may be attached to a platform above the powder bed chamber 3070 and configured to move the arm (and thus the extrusion nozzle 3150) in each of the X-axis and Y-axis directions. In some embodiments, the extrusion nozzle 3150 may be configured to be moved (e.g., via the arm and/or the platform) in the Z-axis direction. The arm may also include a channel to provide the composition to the extrusion nozzle 3150. In some embodiments, the extrusion nozzle 3150 and one or both of the first and second binder printheads 3130 and 3140 are included and respectively attached to a corresponding arm connected at one end to the same platform.

In some embodiments, the extrusion nozzle 3150 is included and is to be utilized to fabricate one or two layers selected from the nonmagnetic layer 300L and the first and second magnetic layers 120L and 220L, and at least one of the remaining layers may be fabricated from the first powder and/or the second powder. For example, the first magnetic layer 120L may be fabricated utilizing the first powder and the extrusion nozzle 3150 may be utilized to fabricate the nonmagnetic layer 300L. In some other embodiments, the first magnetic layer 120L is fabricated utilizing the first powder, the nonmagnetic layer 300L is fabricated utilizing the second powder, and the second magnetic layer 220L is fabricated utilizing the extrusion nozzle 3150.

In some embodiments, the extrusion nozzle 3150 is a first extrusion nozzle, and the additive manufacturing apparatus 3000 further includes a second extrusion nozzle. The second extrusion nozzle may have any configuration that the first extrusion nozzle may have, and the second extrusion nozzle may have a configuration that is the same as or different from the configuration of the first extrusion nozzle. The first and second extrusion nozzles may be independently movable or coupled together to be moved together. In some embodiments, the first extrusion nozzle is configured to provide a first composition including the nonmagnetic precursor material and the second extrusion nozzle is configured to provide a second composition including the magnetic precursor material. Such embodiments could be utilized, for example, to fabricate the first magnetic layer 120L utilizing the first powder, to fabricate the nonmagnetic layer 300L utilizing the first extrusion nozzle, and to fabricate the second magnetic layer 220L utilizing the second composition.

In some embodiments, the first and/or second nozzles are configured to be heated, for example, at their respective openings. For example, the first and second nozzles may include respective heating mechanisms as would be understood by a person of ordinary skill in the art. Heating an extrusion nozzle can be utilized to lower the viscosity of the composition to be extruded. This can be useful when the composition has a relatively high melting point, and thus, extrusion of the composition may be improved (e.g., occurrences of clogging of the extrusion nozzle may be reduced and/or the uniformity of the extrusion flow may be improved) and the composition may quickly solidify and hold its shape after being extruded into an environment having a lower temperature compared to the heated extrusion nozzle.

In some embodiments, the extrusion nozzle 3150 is configured to separately provide a first composition and a second composition. The first composition may include the magnetic precursor material, and the second composition may include the nonmagnetic precursor material. For example, an arm may be attached to the extrusion nozzle 3150 and include a first channel configured to provide the first composition to the extrusion nozzle 3150 and a second channel configured to provide the second composition to the extrusion nozzle 3150. The extrusion nozzle 3150 may be configured to selectively receive one of the first and second compositions, for example, by selectively coupling to one of the first and second channels and by decoupling from (e.g., blocking access to) the other one of the first and second channels. Accordingly, in such embodiments, the extrusion nozzle 3150 may be configured to provide the first composition to form one of the first and second magnetic layers 120L and 220L and to provide the second composition to form the nonmagnetic layer 300L.

Referring to FIG. 20, an additive manufacturing apparatus 4000 includes a frame 4200, a building chamber 4010 in the frame 4200, a moveable build platform 4020 configured to move up and down (e.g., along the Z-axis direction) in the building chamber 4010, a first extrusion nozzle 4030, and a second extrusion nozzle 4040. Feature 4500 illustrates a component being fabricated utilizing the additive manufacturing apparatus 4000. Each of the first and second extrusion nozzles 4030 and 4040 may be configured in any manner that the extrusion nozzle 3150 may be configured in, as illustrated and described herein with reference to FIGS. 17-19, and the first extrusion nozzle 4030 may have a configuration that is the same as or different from a configuration of the second extrusion nozzle 4040. For example, in some embodiments, the first extrusion nozzle 4030 may be configured to provide a first composition including a magnetic material precursor onto the build platform 4020 to form the first magnetic layer 120L and/or the second magnetic layer 220L, and the second extrusion nozzle 4040 may be configured to provide a second composition including a nonmagnetic material precursor onto the build platform 4020 to form the nonmagnetic layer 300L.

In some embodiments, the build platform 4020 is stationary relative to the frame 4200, and the first and second extrusion nozzles 4030 and 4040 are configured to be moved up and down along the Z-axis direction so that the first and second extrusion nozzles 4030 and 4040 can be moved upward as layers of the first and/or second compositions are formed. In some other embodiments, the first and second extrusion nozzles 4030 and 4040 are configured to be moved along the X-axis direction and the Y-axis direction, but not along the Z-axis direction, and the build platform 4020 is moveable along the Z-axis direction and is configured to be moved downward as layers of the first and/or second compositions are formed.

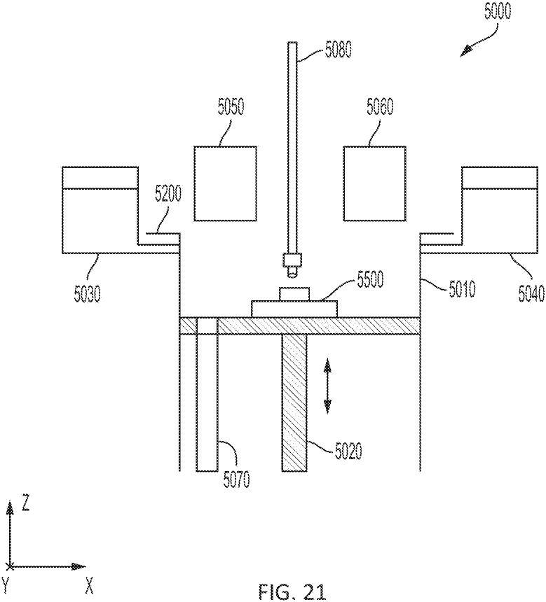

Referring to FIG. 21, an additive manufacturing apparatus 5000 includes a frame 5200, a build vat 5010 in the frame 5200, a moveable build platform 5020 configured to move up and down (e.g., along the Z-axis direction) in the build vat 5010, a first container 5030 to contain a first liquid including the magnetic material precursor and to provide the first liquid to the build vat 5010, a second container 5040 to contain a second liquid including the nonmagnetic material precursor and to provide the second liquid to the build vat 5010, a first light source 5050, a second light source 5060, and an extrusion nozzle 5080. Feature 5500 illustrates a component being fabricated utilizing the additive manufacturing apparatus 5000.

The additive manufacturing apparatus 5000 may include a drain 5070 to allow for liquid to be drained from the build vat 5010. In some embodiments, the drain 5070 is in the build platform 5020.

The first and second containers 5030 and 5040 respectively controllably release the first and second liquids into the build vat 5010. For example, the first container 5030 may release a set amount of the first liquid into the build vat 5010 to form a layer of the first liquid in the build vat 5010 and then stop releasing the first liquid.

Each of the first and second liquids may be processed utilizing a photocuring process. For example, each of the first and second liquids may respectively have properties such that, when exposed to light having a frequency above a set threshold value, at a set value, or within a set range of values, the portions of the exposed liquid harden. The first liquid may be curable at frequencies that are the same as or different from the frequencies at which the second liquid is curable. In some embodiments, the first liquid may include a mixture of the magnetic material precursor and a first photopolymer, and the second liquid may include a mixture of the nonmagnetic material precursor and a second photopolymer that may be the same as or different from the first photopolymer.

The first light source 5050 may be a scanning laser configured to direct a laser beam at multiple positions over a liquid layer in the build vat 5010. For example, the first light source 5050 may be configured to direct the laser beam over a planar region parallel to the X-Y. For example, the first light source 5050 may include a laser source and a scanner coupled to the laser source. The first light source 5050 may be configured to provide the laser beam at a single power or may be configured to vary the power of the laser beam. Accordingly, the first light source 5050 may be configured cure the first liquid and/or the second liquid.

In some embodiments, the first light source 5050 includes a display screen to selectively illuminate one or more planar regions of a liquid layer in the build vat 5010. The display screen may be able to illuminate an entire planar region of the liquid layer and may selectively control which regions of the display screen provide illumination, to thereby selectively control which regions of the liquid layer are illuminated. Accordingly, the display screen may be in close proximity with the liquid layer and oriented parallel to the liquid layer when being utilized to process the liquid layer. In some other embodiments, the display screen may be able to illuminate an entire planar region of the liquid layer, and masks may be utilized (e.g., placed over the display screen) to selectively block one or more regions of the display screen, and thus, selectively control which regions of the liquid layer are illuminated.

The second light source 5060 may be configured in any manner that the first light source 5050 may be configured in, and the second light source 5060 may have a same or different configuration as the first light source 5050 has. In some embodiments, the first light source 5050 is configured to cure the first liquid and the second light source 5060 is configured to cure the second liquid. In some other embodiments, the second light source 5060 is omitted, and the first light source 5050 is configured to cure the first liquid and the second liquid. In some other embodiments, the second light source 5060 is omitted, and the first light source 5050 is configured to cure only one of the first and second liquids.

The additive manufacturing apparatus 5000 is illustrated in FIG. 21 as having a build-up configuration with the first and second light sources 5050 and 5060 and the extrusion nozzle 5080 being above (e.g., above in the Z-axis direction, as shown in FIG. 21) the moveable build platform 5020. When the additive manufacturing apparatus 5000 has a build-up configuration, the moveable build platform 5020 may be moved downward as layers of liquid are processed. For example, a liquid layer may be provided to the build vat 5010 and processed, another liquid layer may be provided on the processed liquid layer, and the other liquid layer may be processed. To avoid mixture between the first and second liquids when switching between the first and second liquids, the liquid in the build vat 5010 may be drained of one liquid selected from the first and second liquids after fabrication utilizing the one liquid is complete and before fabrication utilizing the other liquid selected from the first and second liquids begins. In some embodiments, after the one liquid is drained and before the other liquid is provided to refill the build vat 5010, a cleansing solution may be provided to further remove remnants of the one liquid, the cleansing solution may be drained from the build vat 5010, and the build vat 5010 may be dried.

In some other embodiments, one or both of the first and second light sources 5050 and 5060 may be provided below the moveable build platform 5020.

The extrusion nozzle 5080 may be configured in any manner that the extrusion nozzle 3150 may be configured in, as illustrated and described herein with reference to FIGS. 17-19. For example, in some embodiments, the extrusion nozzle 5080 may be configured to provide a first composition onto the build platform 5020. The first composition may include the magnetic material precursor, and the extrusion nozzle 5080 may be configured to form one selected from the first and second magnetic layers 120L and 220L, or the first composition may include the nonmagnetic material precursor, and the extrusion nozzle 5080 may be configured to form the nonmagnetic layer 300L.

In some embodiments, the extrusion nozzle 5080 is a first extrusion nozzle, and the additive manufacturing apparatus 5000 further includes a second extrusion nozzle. The second extrusion nozzle may have any configuration that the first extrusion nozzle may have, and the first extrusion nozzle may have a configuration that is the same as or different from the second extrusion nozzle. For example, the first extrusion nozzle may be configured to provide a first composition including the magnetic material precursor onto the build platform 5020 to form one selected from the first and second magnetic layers 120L and 220L, and the second extrusion nozzle may be to provide a second composition including the nonmagnetic material precursor onto the build platform 5020 to form the nonmagnetic layer 300L.

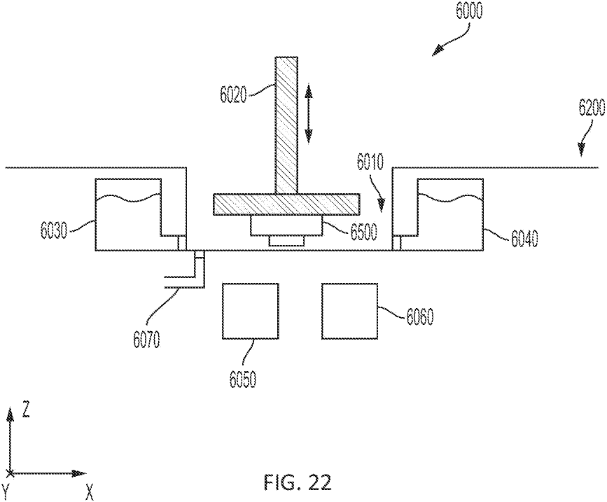

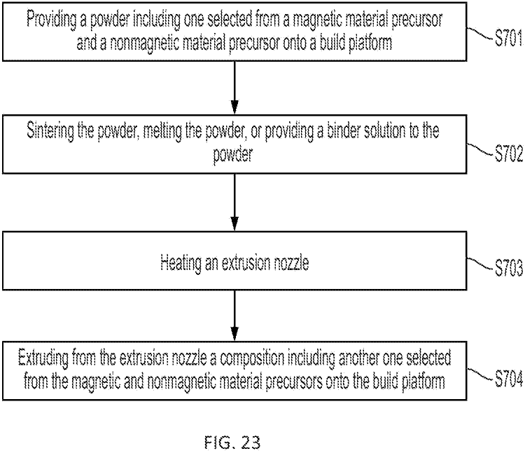

Referring to FIG. 22, an additive manufacturing apparatus 6000 includes a frame 6200, a build vat 6010 in the frame 6200 and including a lower build surface, a moveable build platform 6020 to move up and down (e.g., along the Z-axis direction) in the build vat 6010, a drain 6070 that may be in the lower surface of the moveable build platform 6020, first and second containers 6030 and 6040 to respectively contain first and second liquids and to respectively controllably provide the first and second liquids to the build vat 6010, and first and second light sources 6050 and 6060. Feature 6500 illustrates a component being fabricated utilizing the additive manufacturing apparatus 6000. The additive manufacturing apparatus 6000 includes some components similar to the components of the additive manufacturing apparatus 5000 of FIG. 21, and redundant descriptions may not be repeated and differences will be described. The additive manufacturing apparatus 6000 has a build-down configuration with the first and second light sources 6050 and 6060 being below the lower surface of the build vat 6010 and the moveable build platform 6020 being above the lower surface of the build vat 6010.

During operation, the hardened portion of an initial processed liquid layer may adhere to a lower surface of the moveable build platform 6020, for example, with or without utilizing an adhesive directly on the lower surface of the moveable build platform 6020. Subsequent liquid layers, when processed, may adhere to the processed initial liquid layer, and the moveable build platform 6020 may rise upward (e.g., along the Z-axis direction) as liquid layers are processed to make room for subsequent liquid layers.

In some embodiments, the additive manufacturing apparatus 6000 may further include one or more extrusion nozzles similar to the extrusion nozzles described with respect to the additive manufacturing apparatus 5000 of FIG. 21.

FIGS. 23-27 show methods of additive fabricating at least part of a wireless power transfer device according to some embodiments. Each of the methods illustrated in FIGS. 23-27 may be performed utilizing at least one of the additive manufacturing apparatuses illustrated in FIGS. 15-22.

Referring to FIG. 23, at a first task S701, a powder including one selected from a magnetic material precursor and a nonmagnetic material precursor onto a build platform. At a second task S702, the powder is sintered, melted, or bonded together by providing a binder to the powder. At a third task S703, an extrusion nozzle is heated. At a fourth task S704, a composition including another one selected from the magnetic and nonmagnetic material precursors is extruded onto the build platform from an extrusion nozzle, for example, while the extrusion nozzle is heated. In some embodiments, the powder may include the magnetic material precursor and the first magnetic layer 120L and/or the second magnetic layer 220L may be fabricated utilizing the powder, and the composition may include the nonmagnetic material precursor and the nonmagnetic layer 300L may be fabricated from the extruded composition. In some other embodiments, the powder may include the nonmagnetic material precursor and the powder may be utilized to fabricate the nonmagnetic layer 300L, and the composition may include the magnetic material precursor and the first magnetic layer 120L and/or the second magnetic layer 220L may be fabricated from the extruded composition.

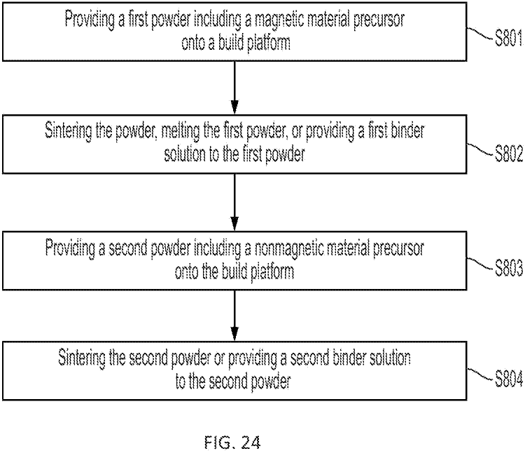

Referring to FIG. 24, at a first task S801, a first powder including a magnetic material precursor is provided onto a build platform. At a second task S802, the first powder is sintered, melted, or bonded together by providing a binder solution to the first powder. At a third task S803, a second powder including a nonmagnetic material precursor is provided onto the build platform. At a fourth task S804, the second powder is sintered or bonded together by providing a second binder solution to the second powder. In some embodiments, the first magnetic layer 120L and/or the second magnetic layer 220L may be fabricated utilizing the first powder, and the nonmagnetic layer 300L may be fabricated utilizing the second powder.

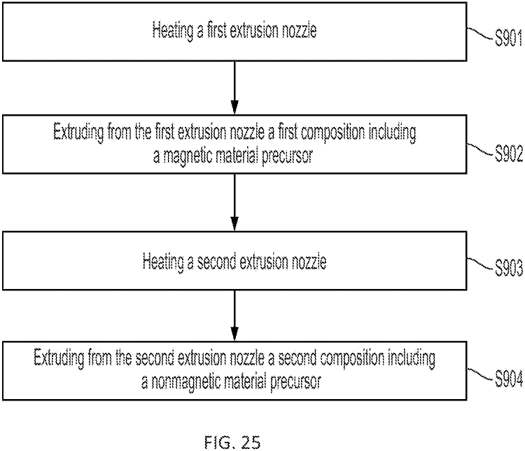

Referring to FIG. 25, at a first task S901, a first extrusion nozzle is heated. At a second task S902, a first composition including a magnetic material precursor is extruded from the first extrusion nozzle. At a third task S903, a second extrusion nozzle is heated. At a fourth task S904, a second composition including a nonmagnetic material precursor is extruded from the second extrusion nozzle. In some embodiments, the first magnetic layer 120L and/or the second magnetic layer 220L may be fabricated from the first composition, and the nonmagnetic layer 300L may be fabricated from the second composition.

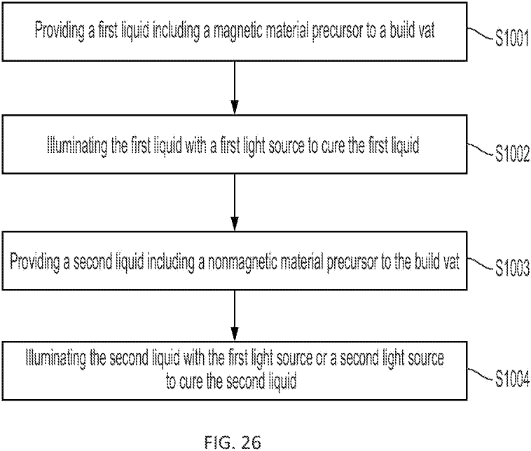

Referring to FIG. 26, at a first task S1001, a first liquid including a magnetic material precursor is provided to a build vat. At a second task S1002, a first light source (e.g., a scanning laser or a display screen) is utilized to illuminate the first liquid to cure the first liquid. At a third task S1003, a second liquid including a nonmagnetic material precursor is provided to the build vat. At a fourth task S1004, the first light source or a second light source (e.g., a scanning laser or a display screen) is utilized to illuminate the second liquid to cure the second liquid. In some embodiments, the first magnetic layer 120L and/or the second magnetic layer 220L may be fabricated from the first liquid, and the nonmagnetic layer 300L may be fabricated from the second liquid.

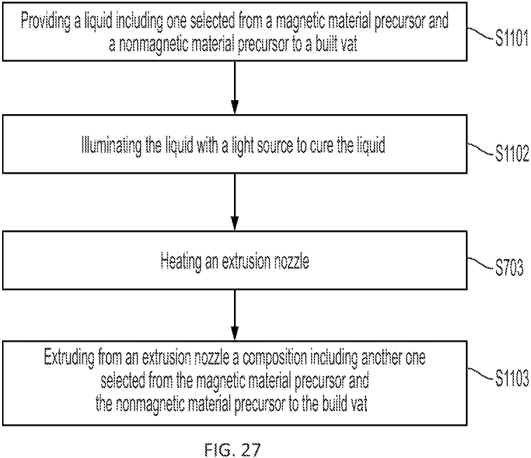

Referring to FIG. 27, at a first task S1101, a liquid including one selected from a magnetic material precursor and a nonmagnetic material precursor is provided to a build vat. At a second task S1102, a light source (e.g., a scanning laser or a display screen) is utilized to illuminate the liquid to cure the liquid. At a third task S1103, an extrusion nozzle is heated. At a fourth task S1104, a composition including another one selected from the magnetic material precursor and the nonmagnetic material precursor is extruded onto the build vat from the extrusion nozzle. In some embodiments, the liquid may include the magnetic material precursor and the first magnetic layer 120L and/or the second magnetic layer 220L may be fabricated utilizing the liquid, and the composition may include the nonmagnetic material precursor and the nonmagnetic layer 300L may be fabricated from the extruded composition. In some other embodiments, the liquid may include the nonmagnetic material precursor and may be utilized to fabricate the nonmagnetic layer 300L, and the composition may include the magnetic material precursor and the first magnetic layer 120L and/or the second magnetic layer 220L may be fabricated from the extruded composition.

In some embodiments, the nonmagnetic layer 300L is fabricated after one magnetic layer selected from the first and second magnetic layers 120L and 220L is fabricated, and the nonmagnetic layer 300L is fabricated on (e.g., directly on) the one magnetic layer. In some other embodiments, the nonmagnetic layer 300L is fabricated first, and the one magnetic layer is fabricated on (e.g., directly on) the nonmagnetic layer 300L. Another magnetic layer selected from the first and second magnetic layers 120L and 220L may be fabricated on (e.g., directly on) the nonmagnetic layer 300L. In some other embodiments, the other magnetic layer is fabricated separately and before or after the one magnetic layer and the nonmagnetic layer 300L are fabricated. The separately fabricated other magnetic layer may be coupled to the nonmagnetic layer 300L on a side of the nonmagnetic layer 300L opposite to the one magnetic layer.

In some embodiments, the one magnetic layer and the nonmagnetic layer 300L are fabricated in a continuous additive manufacturing process. For example, the one magnetic layer and the nonmagnetic layer 300L may be fabricated utilizing a single additive manufacturing apparatus and/or without human intervention between when one of the one magnetic layer and the nonmagnetic layer 300L is fabricated and when the other one of the one magnetic layer and the nonmagnetic layer 300L is fabricated. In some embodiments, the first magnetic layer 120L, the nonmagnetic layer 300L, and the second magnetic layer 220L are all fabricated in a continuous additive manufacturing process.

The first and second magnetic layers 120L and 220L and the nonmagnetic layer 300L may be in a green state after they are additive fabricated. The green layers may include binders utilized during the additive fabrication process, and the green layers may be subjected to one or more after processes, such as debinding and/or sintering, to remove at least some of the binder material to provide the layers in their final state. After processes are not required for the first and second magnetic layers 120L and 220L when these layers are fabricated by melting magnetic powder (e.g., pure ferrite powder) to form a pure magnetic layer (e.g., a pure ferrite layer).

In some embodiments, one or more of the first and second magnetic layers 120L and 220L and the nonmagnetic layer 300L are subjected to an after process before additional layers are fabricated on or coupled to the one or more layers. For example, the first magnetic layer 120L may be additive fabricated in an additive manufacturing apparatus, removed from the additive manufacturing apparatus and subjected to an after process, and then placed back in the additive manufacturing apparatus so that the nonmagnetic layer 300L may be additive fabricated on the first magnetic layer 120L. In some other embodiments, the first magnetic layer 120L and the nonmagnetic layer 300L are fabricated in an additive manufacturing apparatus, removed from the additive manufacturing apparatus, and subjected to an after process. The second magnetic layer 220L may then be additive fabricated on the nonmagnetic layer 300L in the additive manufacturing apparatus or coupled to the nonmagnetic layer 300L.

Organic binders may be released from a green layer during the after process while inorganic binders may be substantially retained in the green layer during the after process due to their tolerance to higher temperatures. In some embodiments, the first magnetic layer 120L and/or the second magnetic layer 220L may be additive fabricated with an organic binder and the nonmagnetic layer 300L may be additive fabricated with an inorganic binder. Accordingly, during the after process, the first magnetic layer 120L and/or the second magnetic layer 220L may release some or all of their respective organic binders and shrink to a final state having a higher density of magnetic (e.g., ferrite) material, while the nonmagnetic layer 300L substantially retains its inorganic binder and does not shrink.

Although some embodiments of additive manufacturing apparatuses and methods of additive manufacturing have been described with reference to the cross-sectional view of the part of the wireless power transfer device as shown in FIG. 14, it will be understood by those of ordinary skill in the art that the configurations of the additive manufacturing apparatuses and the methods of additive manufacturing described herein are not limited by FIG. 14.

In some embodiments of the additive manufacturing apparatuses described herein, the additive manufacturing apparatus is configured to be utilized to additive fabricate at least part of a wireless power transfer device layer-by-layer along a thickness direction (e.g., along the Z-axis direction as shown in FIG. 14) in a manner such that each layer is uniform in material, and in some other embodiments of the additive manufacturing apparatuses described herein, the additive manufacturing apparatus is configured to be utilized to additive fabricate at least part of a wireless power transfer device layer-by-layer along the thickness direction in such a manner that each layer is either uniform in material or includes at least two regions including different materials.

In some embodiments of the methods of additive fabricating processes described herein, the method includes additive fabricating at least part of a wireless power transfer device layer-by-layer along the thickness direction in a manner such that each layer is uniform in material, and in some other embodiments of the additive fabricating processes described herein, the method includes additive fabricating at least part of a wireless power transfer device layer-by-layer along the thickness direction in a manner such that each layer is either uniform in material or includes at least two regions including different materials.

For example, in some embodiments when the first magnetic layer 120L, the nonmagnetic layer 300L, and the second magnetic layer 220L each have uniform thicknesses, and the at least part of the wireless power transfer device is to be additive fabricated layer-by-layer (e.g., each layer) along the thickness direction (e.g., from a bottom surface of the first magnetic layer 120L toward (e.g., to) a top surface of the second magnetic layer 220L), an additive manufacturing apparatus from among the additive manufacturing apparatuses described herein to be utilized to additive fabricate the at least part of the wireless power transfer device may be configured to additive fabricate each layer in a manner such that each layer is uniform in material.

In some other embodiments when the first magnetic layer 120L, the nonmagnetic layer 300L, and/or the second magnetic layer 220L have non-uniform thicknesses, and the at least part of the wireless power transfer device is to be additive fabricated layer-by-layer along the thickness direction, an additive manufacturing apparatus from among the additive manufacturing apparatuses described herein to be utilized to additive fabricate the at least part of the wireless power transfer device may be configured to additive fabricate each layer in a manner such that each layer is either uniform in material or includes at least two regions including different materials.

In some other embodiments, the at least part of the wireless power transfer device is to be additive fabricated layer-by-layer along a direction other than the thickness direction. For example, some of the additive manufacturing apparatuses described herein may be configured to additive fabricate at least part of a wireless power transfer device from side to side (e.g., along a direction corresponding to (e.g., parallel to) the first axis 100A or the second axis 200A, see FIG. 3).

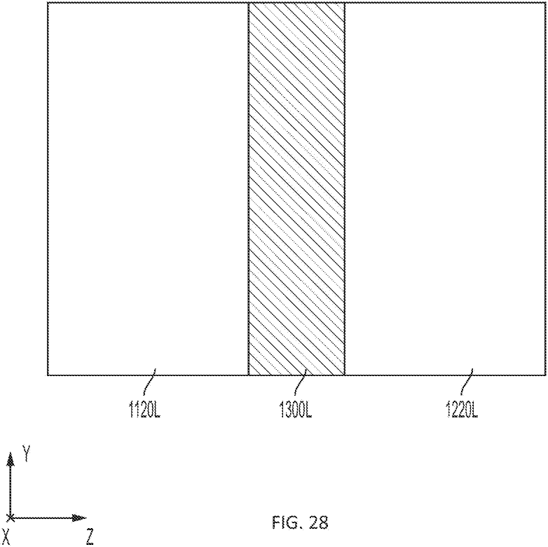

FIG. 28 shows a cross-sectional view of a part of a wireless power transfer device according to some embodiments. Referring to FIG. 28, some manufacturing apparatuses described herein may be configured to additive fabricate at least part of a wireless power transfer device layer-by-layer along the Y-axis direction as shown in FIG. 28, and some methods of additive manufacturing described herein may be utilized to additive fabricate the at least part of the wireless power transfer device along the Y-axis direction as shown in FIG. 28. In some embodiments, the Y-axis direction shown in FIG. 28 may correspond (e.g., be parallel to) the first axis 100A or the second axis 200A (see FIG. 3). Moreover, as noted above, the device may be otherwise oriented (e.g., rotated 90 degrees or at other orientations) and the spatially relative descriptors used herein should be interpreted accordingly.

The layers additively fabricated during the manufacturing of the at least part of the wireless power transfer device may be parallel to the X-Z plane as shown in FIG. 28. One or more of the additively fabricated layers may include three regions: a first region including a first material corresponding to the first magnetic layer 1120L, a second region including a second material corresponding to the nonmagnetic layer 1300L, and a third region including a third material corresponding to the second magnetic layer 1220L. In some other embodiments, the at least part of the wireless power transfer device to be additively fabricated includes the nonmagnetic layer 1300L and only one of the first and second magnetic layers 1120L and 1220L, and one or more of the additively fabricated layers may include two regions: a region including a material corresponding to the nonmagnetic layer 1300L and another region including another material corresponding to the first magnetic layer 1120L or the second magnetic layer 1220L.

In some embodiments, the at least part of the wireless power transfer device to be additively fabricated includes the entire first magnetic layer 120L/1120L, the entire nonmagnetic layer 300L/1300L, and the entire second magnetic layer 220L/1200L. In some embodiments, the at least part of the wireless power transfer device to be additively fabricated includes only a portion of the first magnetic layer 120L/1120L corresponding to (e.g., overlapping in the plan view) the area of overlap 300, only a portion of the nonmagnetic layer 300L/1300L corresponding to the area of overlap 300, and only a portion of the second magnetic layer 220L/1220L corresponding to the area of overlap 300. In some embodiments, the at least part of the wireless power transfer device to be additively fabricated includes only a portion of the first magnetic layer 120L/1120L corresponding to the nonmagnetic layer 300L/1300L, the entire nonmagnetic layer 300L/1300L, and only a portion of the second magnetic layer 220L/1220L corresponding to the nonmagnetic layer 300L/1300L.

The system and/or any other relevant devices or components according to embodiments of the present invention described herein may be implemented utilizing any suitable hardware, firmware (e.g. an application-specific integrated circuit), software, or a combination of software, firmware, and hardware. For example, the various components of the system may be formed on one integrated circuit (IC) chip or on separate IC chips. Further, the various components of the system may be implemented on a flexible printed circuit film, a tape carrier package (TCP), a printed circuit board (PCB), or formed on one substrate. Further, the various components of the system may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

Although some embodiments of the present disclosure have disclosed herein, the present disclosure is not limited thereto, and the scope of the present disclosure is defined by the appended claims and equivalents thereof.

What is claimed is:

1. A wireless power transfer device, comprising:
a first transmitting coil oriented along a first axis and comprising a first ferrite rod;
a second transmitting coil on the first transmitting coil, oriented along a second axis different from the first axis, and comprising a second ferrite rod; and
a nonmagnetic layer magnetically decoupling the first ferrite rod from the second ferrite rod in an area of overlap between the first and second ferrite rods, the first ferrite rod and the nonmagnetic layer being fabricated utilizing additive manufacturing.

2. The wireless power transfer device of claim 1, wherein at least a portion of the first ferrite rod consists of ferrite.

3. The wireless power transfer device of claim 1, where the first ferrite rod comprises a composition of ferrite and a binder.

4. The wireless power transfer device of claim 3, wherein the composition comprises ferrite at 95 wt% or more.

5. The wireless power transfer device of claim 1, wherein the nonmagnetic layer comprises a polymer.

6. The wireless power transfer device of claim 1, wherein the nonmagnetic layer comprises an inorganic material.

7. The wireless power transfer device of claim 1, wherein the nonmagnetic layer is directly on the first ferrite rod.

8. The wireless power transfer device of claim 1, wherein the second ferrite rod is fabricated utilizing additive manufacturing.

9. The wireless power transfer device of claim 1, wherein one selected from the group consisting of the first ferrite rod and the nonmagnetic layer is fabricated directly onto another one selected from the group consisting of the first ferrite rod and the nonmagnetic layer.

10. The wireless power transfer device of claim 1, wherein the first ferrite rod and the nonmagnetic layer are each fabricated utilizing a single additive manufacturing apparatus.

11. An additive manufacturing apparatus, comprising:
a ferrite material fabrication structure configured to additive fabricate a ferrite rod from a ferrite material precursor; and
a nonmagnetic material fabrication structure configured to additive fabricate a nonmagnetic layer from a nonmagnetic material precursor, the nonmagnetic layer being on the ferrite rod.

12. The additive manufacturing apparatus of claim 11, comprising:
a movable build platform;
a powder reservoir to contain a powder comprising one of the ferrite and nonmagnetic material precursors;
a leveling mechanism configured to move the powder from the powder reservoir onto the build platform;
at least one of:
a laser configured to sinter or melt the powder on the build platform, and
a binder printhead configured to provide a binder solution to the powder on the build platform; and
at least one extrusion nozzle configured to provide a composition comprising another one of the ferrite and nonmagnetic material precursors.

13. The additive manufacturing apparatus of claim 11, comprising:
a movable build platform;
a first powder reservoir to contain a first powder comprising the ferrite material precursor;
a second powder reservoir to contain a second powder comprising the nonmagnetic material precursor; and
a leveling mechanism configured to move at least one of the first powder and the second powder respectively from the first powder reservoir and the second powder reservoir onto the build platform.

14. The additive manufacturing apparatus of claim 13, wherein the leveling mechanism is a first leveling mechanism configured to move the first powder onto the build platform, and
wherein the additive manufacturing apparatus further comprises a second leveling mechanism configured to move the second powder onto the build platform.

15. The additive manufacturing apparatus of claim 13, further comprising:
a first laser configured to melt or sinter the first powder on the build platform; and
at least one of:
a second laser configured to sinter the second powder on the build platform, and
a binder printhead configured to provide a binder solution to the second powder on the build platform.

16. The additive manufacturing apparatus of claim 13, further comprising:
a first binder printhead configured to provide a first binder solution to the first powder on the build platform; and
a second binder printhead configured to provide a second binder solution to the second powder on the build platform.

17. The additive manufacturing apparatus of claim 11, comprising:
a first extrusion nozzle configured to provide a first composition comprising the ferrite material precursor; and
a second extrusion nozzle configured to provide a second composition comprising the nonmagnetic material precursor.

18. The additive manufacturing apparatus of claim 17, wherein the first extrusion nozzle is configured to be heated during extrusion and/or the second extrusion nozzle is configured to be heated during extrusion.

19. The additive manufacturing apparatus of claim 17, wherein the first composition is a solid filament or a paste and/or the second composition is a solid filament or a paste.

20. The additive manufacturing apparatus of claim 11, comprising:
a first container to contain a first liquid comprising the ferrite material precursor and configured to provide the first liquid to a build vat;
a second container to contain a second liquid comprising the nonmagnetic material precursor and configured to provide the second liquid to the build vat; and
a light source configured to cure at least one selected from the first liquid and the second liquid.

21. The additive manufacturing apparatus of claim 20, wherein the light source is a first light source configured to cure the first liquid, and
wherein the additive manufacturing apparatus further comprises a second light source configured to cure the second liquid.

22. The additive manufacturing apparatus of claim 11, comprising:
a container to hold a liquid comprising one of the ferrite and nonmagnetic material precursors and configured to provide the liquid to a build vat;
a light source configured to cure the liquid; and
at least one extrusion nozzle configured to provide a composition comprising another one of the ferrite and nonmagnetic material precursors.

23. A method of fabricating a wireless power transfer device comprising a ferrite layer and a nonmagnetic layer on the ferrite layer, the method comprising:
utilizing a ferrite material precursor to additive fabricate the ferrite layer; and
utilizing a nonmagnetic material precursor to additive fabricate the nonmagnetic layer.

24. The method of claim 23, comprising:
providing a powder comprising one selected from the ferrite and nonmagnetic material precursors onto a build platform;
sintering the powder, melting the powder, or providing a binder solution to the powder; and
extruding from an extrusion nozzle a composition comprising another one selected from the ferrite and nonmagnetic material precursors onto the build platform.

25. The method of claim 23, wherein the fabricating the ferrite layer comprises:
providing a first powder comprising the ferrite material precursor onto a build platform; and
sintering the first powder, melting the first powder, or providing a first binder solution to the first powder, and
wherein the fabricating the nonmagnetic layer comprises:
providing a second powder comprising the nonmagnetic material precursor onto the build platform; and
sintering the second powder or providing a second binder solution to the second powder.

26. The method of claim 23, wherein the fabricating the ferrite layer comprises extruding from a first extrusion nozzle a first composition comprising the ferrite material precursor, and
wherein the fabricating the nonmagnetic layer comprises extruding from a second extrusion nozzle a second composition comprising the nonmagnetic material precursor.

27. The method of claim 26, wherein the first extrusion nozzle is heated during the extruding of the first composition and/or the second extrusion nozzle is heated during the extruding of the second composition.

28. The method of claim 26, wherein the first composition is a solid filament or a paste and/or the second composition is a solid filament or a paste.

29. The method of claim 23, wherein the fabricating the ferrite layer comprises:
providing a first liquid comprising the ferrite material precursor to a building vat;
illuminating the first liquid to cure the first liquid;
providing a second liquid comprising the nonmagnetic material precursor to the building vat; and
illuminating the second liquid to cure the second liquid.

30. The method of claim 29, wherein the illuminating the first liquid comprises utilizing a first light source to illuminate the first liquid, and
wherein the illuminating the second liquid comprises utilizing a second light source to illuminate the second liquid.

31. The method of claim 23, comprising:
providing a liquid comprising one selected from the ferrite and nonmagnetic material precursors to a build vat;
illuminating the liquid to cure the liquid; and
extruding from an extrusion nozzle a composition comprising another one selected from the ferrite and nonmagnetic material precursors.

32. The method of claim 23, wherein the fabricating the nonmagnetic layer occurs after the fabricating the ferrite layer, and the nonmagnetic layer is fabricated on the ferrite layer.

33. The method of claim 23, wherein the fabricating the ferrite layer occurs after the fabricating the nonmagnetic layer, and the ferrite layer is fabricated on the nonmagnetic layer.

34. The method of claim 23, wherein the fabricating the ferrite layer and the fabricating the nonmagnetic layer is a continuous process.

35. The method of claim 23, wherein the ferrite layer is a first ferrite layer and the wireless power transfer device further comprises a second ferrite layer spaced apart from the first ferrite layer with the nonmagnetic layer therebetween, and
wherein the method further comprises utilizing additive manufacturing to fabricate the second ferrite layer.

36. The method of claim 35, wherein the second ferrite layer is fabricated separate from the first ferrite layer and the nonmagnetic layer, and
wherein the second ferrite layer is coupled to the nonmagnetic layer after it is fabricated.
